(19) United States
(12) Patent Application Publication
(10) Pub. No.: US 2026/0160616 A1
(43) Pub. Date: Jun. 11, 2026

(54) INPUT DEVICE AND METHOD FOR CONTROLLING INPUT DEVICE

(71) Applicant: TDK Corporation, Tokyo (JP)

(72) Inventors: Shuto ONO, Tokyo (JP); Satoshi SASAKI, Tokyo (JP); Yasuyuki SATOH, Tokyo (JP); Kento IZUMI, Tokyo (JP)

(73) Assignee: TDK Corporation, Tokyo (JP)

(21) Appl. No.: 19/182,016

(22) Filed: Apr. 17, 2025

(30) Foreign Application Priority Data
May 1, 2024 (JP) 2024-074464

(51) Int. Cl. G01L 1/16; G01L 1/26

(52) U.S. Cl. CPC G01L 1/16; G01L 1/26

(57) ABSTRACT

An input device includes an operation section and a controller. The operation section includes a piezoelectric element being arranged to receive a force from an operation body. The piezoelectric element includes one piezoelectric body including a first portion being arranged to be displaced through application of a voltage and a second portion being arranged to generate an electric charge through displacement. The operation section is arranged to output a signal responding to the electric charge generated in the second portion. The controller is arranged to acquire information regarding the force received from the operation body based on the signal output from the operation section.

### CROSS-REFERENCE TO RELATED APPLICATIONS

This application is based upon and claims the benefit of priority from Japanese Patent Application No. 2024-074464, filed on May 1, 2024, the entire contents of which are incorporated herein by reference.

### BACKGROUND

### Field

The present disclosure relates to an input device and a method for controlling the input device.

### Description of the Related Art

Known input devices include an operation section (for example, refer to Japanese Unexamined Patent Publication No. 2021-57297). The operation section includes a housing that receives a force from an operation body, and a plurality of piezoelectric bodies are separated from each other in the housing. In the input device, a voltage is applied to any one of the plurality of piezoelectric bodies. The operation section is arranged to output a signal responding to an electric charge generated in the piezoelectric body to which no voltage is applied.

### SUMMARY

In the input device described above, through applying the voltage to any one of the plurality of piezoelectric bodies, the piezoelectric body to which the voltage is applied is displaced. A displacement of the piezoelectric body to which the voltage is applied is transmitted to the piezoelectric body to which no voltage is applied via the housing. Hereinafter, the piezoelectric body to which the voltage is applied may be referred to as a “first piezoelectric body”, and the piezoelectric body to which no voltage is applied may be referred to as a “second piezoelectric body”. When receiving a force on the housing from the operation body, a restraint force responding to the force acts on the housing. Therefore, the force received on the housing from the operation body affects ease of transmission of displacement between the first piezoelectric body and the second piezoelectric body via the housing. As a result, the displacement of the second piezoelectric body changes responding to the force received from the operation body. In a case where the displacement of the second piezoelectric body changes, an electric charge generated in the second piezoelectric body also changes. The input device described above acquires information regarding the force received from the operation body by utilizing the fact that ease of transmission of displacement between the first piezoelectric body and the second piezoelectric body via the housing changes responding to the force received from the operation body. However, in the input device described above, since the displacement of the first piezoelectric body is transmitted to the second piezoelectric body via the housing, there is room for improvement in accuracy of the information regarding the force received from the operation body.

An object of one aspect of the present disclosure is to provide an input device that improves accuracy of information regarding a force received from an operation body.

An object of another aspect of the present disclosure is to provide a method for controlling an input device that improves accuracy of information regarding a force received from an operation body.

An input device according to one aspect includes an operation section and a controller. The operation section includes a piezoelectric element. The piezoelectric element is arranged to receive a force from an operation body, and includes one piezoelectric body including a first portion and a second portion. The first portion is arranged to be displaced through application of a voltage. The second portion is arranged to generate an electric charge through displacement. The operation section is arranged to output a signal responding to the electric charge generated in the second portion. The controller is arranged to acquire information regarding the force received from the operation body based on the signal output from the operation section.

In the one aspect, the operation section includes the piezoelectric element arranged to receive the force from the operation body, and including one piezoelectric body including the first portion and the second portion. The first portion is arranged to be displaced through application of the voltage. The second portion is arranged to generate the electric charge through a displacement. In a case where the first portion is displaced in the one piezoelectric body, the displacement of the first portion is transmitted to the second portion, and the second portion is displaced. When receiving the force on the piezoelectric element from the operation body, a restraint force responding to the force acts on one piezoelectric body including the first portion and the second portion. Therefore, the force received on the piezoelectric element from the operation body affects ease of the displacement of the second portion. That is, when receiving the force on the piezoelectric element from the operation body, the displacement of the second portion changes responding to the force. As the displacement of the second portion changes, the electric charge generated in the second portion also changes.

As described above, in the one aspect, the second portion is displaced through the transmission of the displacement of the first portion, and the displacement of the second portion changes responding to the force received from the operation body. Here, in a configuration in which the displacement of the first portion is not appropriately transmitted to the second portion, there is a possibility that the displacement of the second portion does not change responding to the force received from the operation body. That is, the ease of transmission of the displacement between the first portion and the second portion affects accuracy of the information regarding the force received from the operation body. In the one aspect, since the first portion and the second portion are included in one piezoelectric body, the displacement of the first portion is easily transmitted to the second portion as compared with a configuration in which the first portion and the second portion are included in separate piezoelectric bodies.

As described above, the one aspect improves the accuracy of the information regarding the force received from the operation body.

In a method for controlling an input device according to another aspect, the input device includes an operation section including a piezoelectric element. The piezoelectric element is arranged to receive a force from an operation body, and includes one piezoelectric body including a first portion and a second portion. The first portion is arranged to be displaced through application of a voltage. The second portion is arranged to generate an electric charge through displacement. The operation section is arranged to output a signal responding to the change generated in the second portion. The method for controlling the input device according to the other aspect includes applying the voltage to the first portion, acquiring the signal output from the operation section, and acquiring information regarding the force received from the operation body based on the acquired signal.

In the other aspect, the voltage is applied to the first portion. Through applying the voltage to the first portion, the first portion is displaced. As a result, the displacement of the first portion is transmitted to the second portion, and the second portion is displaced. When receiving the force on the piezoelectric element from the operation body, a restraint force responding to the force acts on one piezoelectric body including the first portion and the second portion. Therefore, the force received on the piezoelectric element from the operation body affects ease of the displacement of the second portion. That is, when receiving the force on the piezoelectric element from the operation body, the displacement of the second portion changes responding to the force. As the displacement of the second portion changes, the electric charge generated in the second portion also changes.

In the other aspect, since the voltage is applied to the first portion included in one piezoelectric body together with the second portion, the displacement of the first portion due to the application of the voltage is easily transmitted to the second portion as compared with a configuration in which the first portion and the second portion are included in separate piezoelectric bodies.

As described above, the one aspect improves the accuracy of the information regarding the force received from the operation body.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a block diagram of an input device according to an embodiment;

FIG. 2 is a perspective diagram illustrating a piezoelectric element;

FIG. 3 is an exploded perspective diagram of the piezoelectric element;

FIG. 4 is a diagram illustrating a cross-sectional configuration of the piezoelectric element;

FIG. 5 is a diagram illustrating a cross-sectional configuration of the piezoelectric element;

FIG. 6 is a circuit diagram illustrating an example of the input device according to the present embodiment;

FIG. 7 is a diagram illustrating an example of control processing in the input device;

FIG. 8 is a diagram illustrating an example of control processing in the input device;

FIG. 9 is an exploded perspective diagram of a piezoelectric element;

FIG. 10 is a diagram illustrating a cross-sectional configuration of the piezoelectric element;

FIG. 11 is a perspective diagram of a piezoelectric element;

FIG. 12 is an exploded perspective diagram of the piezoelectric element;

FIG. 13 is a diagram illustrating a cross-sectional configuration of the piezoelectric element;

FIG. 14 is a perspective diagram of a piezoelectric element;

FIG. 15 is an exploded perspective diagram of the piezoelectric element;

FIG. 16 is a diagram illustrating a cross-sectional configuration of the piezoelectric element;

FIG. 17 is a perspective diagram of a piezoelectric element;

FIG. 18 is an exploded perspective diagram of the piezoelectric element;

FIG. 19 is a diagram illustrating a cross-sectional configuration of the piezoelectric element;

FIG. 20 is a diagram illustrating a cross-sectional configuration of the piezoelectric element;

FIG. 21 is a perspective diagram of a piezoelectric element;

FIG. 22 is a diagram illustrating a cross-sectional configuration of the piezoelectric element;

FIG. 23 is a perspective diagram of a piezoelectric element;

FIG. 24 is a diagram illustrating a cross-sectional configuration of the piezoelectric element;

FIG. 25 is a perspective diagram of a piezoelectric element;

FIG. 26 is a diagram illustrating a cross-sectional configuration of the piezoelectric element;

FIG. 27 is a diagram illustrating a cross-sectional configuration of the piezoelectric element; and

FIG. 28 is a flowchart illustrating an example of control processing in the input device.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

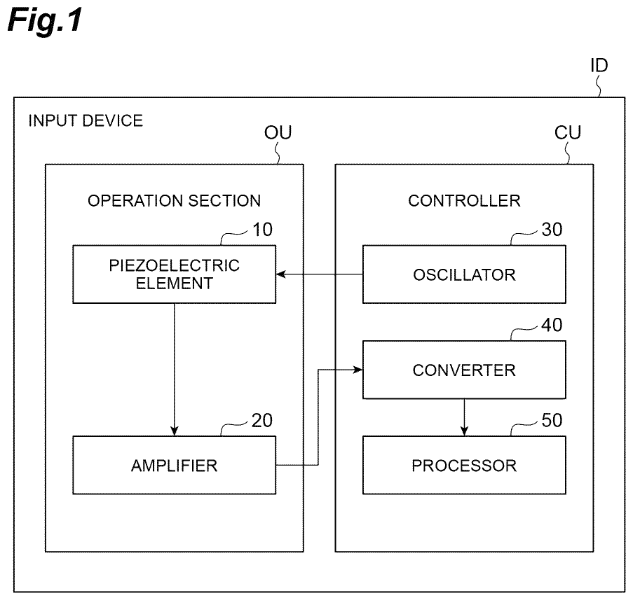

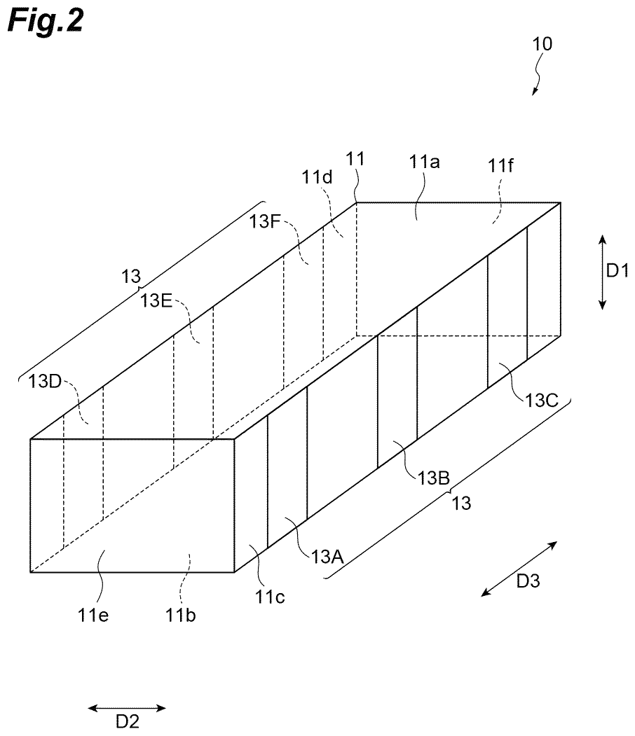

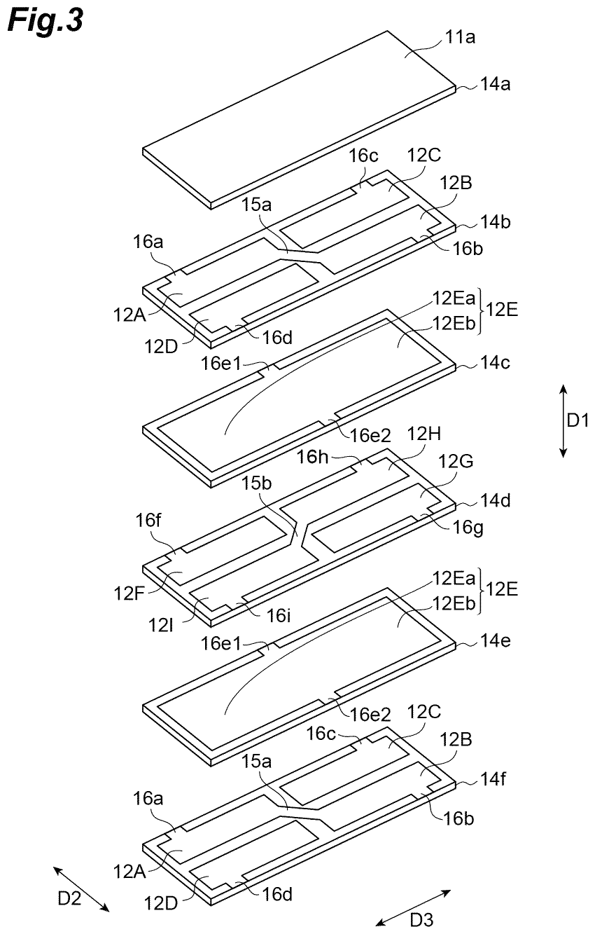

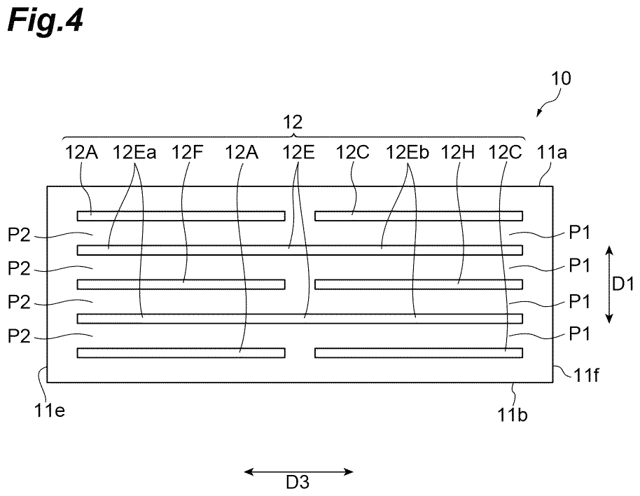

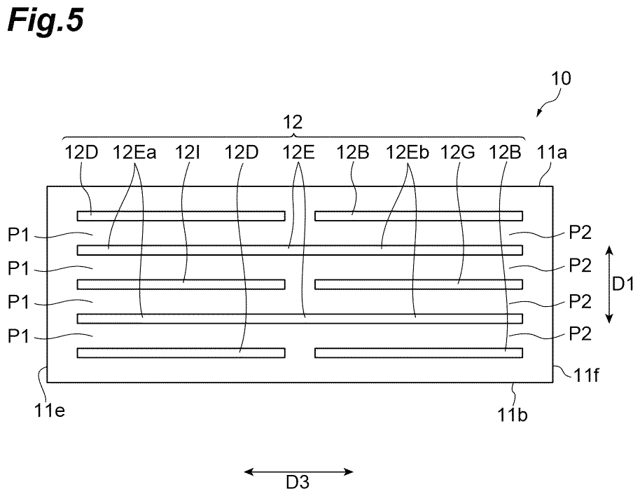

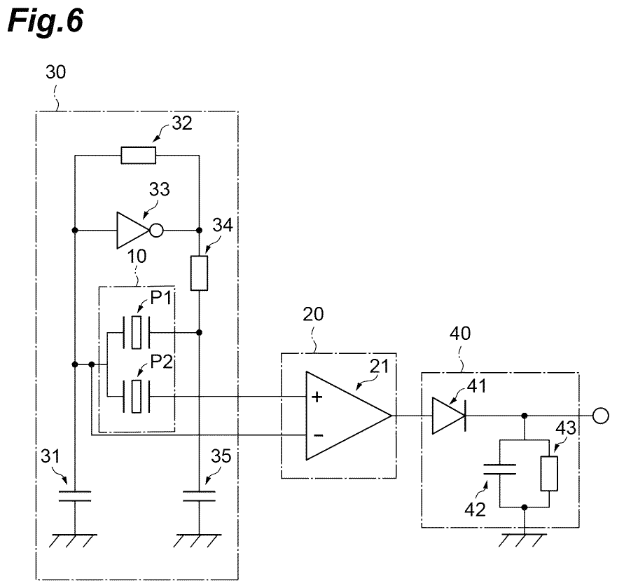

A configuration of an input device ID according to the present embodiment will be described with reference to FIGS. 1 to 6. FIG. 1 is a block diagram of an input device according to the present embodiment. FIG. 2 is a perspective diagram illustrating a piezoelectric element. FIG. 3 is an exploded perspective diagram of the piezoelectric element. FIGS. 4 and 5 are diagrams illustrating a cross-sectional configuration of the piezoelectric element. FIG. 6 is a circuit diagram illustrating an example of the input device according to the present embodiment. In FIGS. 4 and 5, hatching is omitted to clearly illustrate each part. As illustrated in FIG. 1, the input device ID includes an operation section OU and a controller CU. The operation section OU includes a piezoelectric element 10 and an amplifier 20.

In the input device ID, the piezoelectric element 10 is arranged to receive a force from an operation body. That is, the piezoelectric element 10 receives a force from an operation body. The operation body includes, for example, a part of a living body, an object covering a part of the living body, or an object held by the living body. The part of the living body includes, for example, a finger of a human body. The object covering a part of the living body includes, for example, a glove worn on a hand of the human body. The object held by the living body includes, for example, an operation member.

As illustrated in FIGS. 2 to 5, the piezoelectric element 10 includes one piezoelectric body 11, an internal electrode 12, and an external electrode 13. In the present embodiment, the piezoelectric body 11 has a rectangular parallelepiped shape. The rectangular parallelepiped shape includes, for example, a rectangular parallelepiped shape in which corner portions and ridge portions are chamfered, and a rectangular parallelepiped shape in which the corner portions and the ridge portions are rounded. The piezoelectric body 11 includes a pair of principal surfaces 11a and 11b, a pair of side surfaces 11c and 11d, and a pair of end surfaces 11e and 11f. The pair of principal surfaces 11a and 11b oppose each other in a first direction D1. The pair of side surfaces 11c and 11d oppose each other in a second direction D2. The pair of end surfaces 11e and 11f oppose each other in a third direction D3. The second direction D2 intersects the first direction D1. The third direction D3 intersects the first direction D1 and the second direction D2. In the present embodiment, the first direction D1, the second direction D2, and the third direction D3 are orthogonal to each other. The principal surfaces 11a and 11b, the side surfaces 11c and 11d, and the end surfaces 11e and 11f have, for example, rectangular shapes. The rectangular shape includes, for example, a shape in which each corner is chamfered and a shape in which each corner is rounded.

The pair of principal surfaces 11a and 11b connect the side surface 11c and the side surface 11d and extend in the second direction D2. The pair of principal surfaces 11a and 11b connect the end surface 11e and the end surface 11f and extend in the third direction D3. The pair of side surfaces 11c and 11d connect the principal surface 11a and the principal surface 11b and extend in the first direction D1. The pair of side surfaces 11c and 11d connect the end surface 11e and the end surface 11f and extend in the third direction D3. The pair of end surfaces 11e and 11f connect the principal surface 11a and the principal surface 11b and extend in the first direction D1. The pair of end surfaces 11e and 11f connect the side surface 11c and the side surface 11d and extend in the second direction D2.

As illustrated in FIG. 3, in the present embodiment, the piezoelectric body 11 includes at least a plurality of piezoelectric layers 14a, 14b, 14c, 14d, 14e, and 14f. The piezoelectric body 11 is formed through, for example, laminating the plurality of piezoelectric layers 14a to 14f. In the present embodiment, the piezoelectric layers 14a to 14f are arranged in this order in the first direction D1. In the present embodiment, the principal surface 11a of the piezoelectric body 11 includes an outer surface of the piezoelectric layer 14a. The piezoelectric body 11 also includes one or more piezoelectric layers located between the plurality of piezoelectric layers 14a to 14f. A part of the piezoelectric body 11 includes each of the piezoelectric layers 14a to 14f. A direction in which the plurality of piezoelectric layers 14a to 14f are laminated is, for example, the first direction D1. In the present embodiment, each of the piezoelectric layers 14a, 14b, 14c, 14d, 14e, and 14f has the rectangular shape, when viewed from the first direction D1. The plurality of piezoelectric layers 14a to 14f include a piezoelectric ceramic material. That is, the piezoelectric body 11 includes a piezoelectric ceramic material. The piezoelectric body 11 includes PZT[Pb(Zr, Ti)O₃], PT (PbTiO₃), PLZT[(Pb, La)(Zr, Ti)O₃], or barium titanate (BaTiO₃) as the piezoelectric ceramic material. The plurality of piezoelectric layers 14a to 14f are composed of a sintered body of a ceramic green sheet including the above-described piezoelectric ceramic material. The plurality of piezoelectric layers 14a to 14f are integrated to such an extent that boundaries between the piezoelectric layers cannot be visually recognized in practice.

The internal electrode 12 is disposed in the piezoelectric body 11. The internal electrode 12 includes a conductive material. The electrically conductive material includes, for example, Ag/Pd, Pt, Pd, or Cu. The internal electrode 12 includes as, for example, a sintered body of an electrically conductive paste containing the above-described electrically conductive material.

In the present embodiment, the internal electrode 12 includes a pair of internal electrodes 12A and 12B, a pair of internal electrodes 12C and 12D, a plurality of internal electrodes 12E, a pair of internal electrodes 12F and 12G, and a pair of internal electrodes 12H and 12I. That is, in the present embodiment, the piezoelectric element 10 includes the plurality of internal electrodes 12A, 12B, 12C, 12D, 12E, 12F, 12G, 12H, and 12I.

The pair of internal electrodes 12A and 12B and the pair of internal electrodes 12C and 12D are disposed on the piezoelectric layer 14b and the piezoelectric layer 14f. That is, the pair of internal electrodes 12A and 12B and the pair of internal electrodes 12C and 12D are located in the same layer.

The internal electrodes 12A and 12B are disposed, for example, at one diagonal of the rectangular shape of the piezoelectric body 11. The one diagonal includes a corner formed by the side surface 11d and the end surface 11e and a corner formed by the side surface 11c and the end surface 11f, when viewed from the first direction D1. In the present embodiment, the internal electrode 12A is disposed at the corner formed by the side surface 11d and the end surface 11e, and the internal electrode 12B is disposed at the corner portion formed by the side surface 11c and the end surface 11f.

The internal electrodes 12C and 12D are disposed, for example, at the other diagonal of the rectangular shape of the piezoelectric body 11. The other diagonal includes a corner formed by the side surface 11d and the end surface 11f and a corner formed by the side surface 11c and the end surface 11e, when viewed from the first direction D1. In the present embodiment, the internal electrode 12C is disposed at the corner formed by the side surface 11d and the end surface 11f, and the internal electrode 12D is disposed at the corner formed by the side surface 11c and the end surface 11e.

In the piezoelectric layer 14b and the piezoelectric layer 14f, the internal electrode 12A and the internal electrode 12C are adjacent to the side surface 11d, and the internal electrode 12B and the internal electrode 12D are adjacent to the side surface 11c. In the present embodiment, the internal electrode 12A and the internal electrode 12B are physically and electrically connected by a connection portion 15a. The connection portion 15a extends, for example, in a diagonal direction of the one diagonal.

The internal electrode 12E is disposed on the piezoelectric layer 14c and the piezoelectric layer 14e. The internal electrode 12E has, for example, the rectangular shape. In the present embodiment, the internal electrode 12E has the rectangular shape slightly smaller than the piezoelectric body 11, when viewed from the first direction D1. In the present embodiment, the internal electrode 12E includes an internal electrode 12Ea and an internal electrode 12Eb. The internal electrode 12Ea is closer to the end surface 11e than the center of the piezoelectric layers 14c and 14e in the third direction D3, when viewed from the first direction D1. The internal electrode 12Eb is closer to the end surface 11f than the center of the piezoelectric layers 14c and 14e in the third direction D3, when viewed from the first direction D1. In the present embodiment, the internal electrode 12Ea and the internal electrode 12Eb are integrated.

The pair of internal electrodes 12F and 12G and the pair of internal electrodes 12H and 12I are disposed on the piezoelectric layer 14d. That is, the pair of internal electrodes 12F and 12G and the pair of internal electrodes 12H and 12I are located in the same layer.

The internal electrodes 12F and 12G are disposed, for example, at the one diagonal of the rectangular shape of the piezoelectric body 11. In the present embodiment, the internal electrode 12F is disposed at the corner formed by the side surface 11d and the end surface 11e, and the internal electrode 12G is disposed at the corner formed by the side surface 11c and the end surface 11f.

The internal electrodes 12H and 12I are disposed, for example, at the other diagonal of the rectangular shape of the piezoelectric layer 14c. In the present embodiment, the internal electrode 12H is disposed at the corner formed by the side surface 11d and the end surface 11f, and the internal electrode 12I is disposed at the corner formed by the side surface 11c and the end surface 11e.

In the piezoelectric layer 14d, the internal electrode 12F and the internal electrode 12H are adjacent to the side surface 11d, and the internal electrode 12G and the internal electrode 12I are adjacent to the side surface 11c. In the present embodiment, the internal electrode 12H and the internal electrode 12I are physically and electrically connected by a connection portion 15b. The connection portion 15b extends, for example, in a diagonal direction of the other diagonal.

In the present embodiment, the piezoelectric body 11 includes connection conductors 16a, 16b, 16c, 16d, 16e1, 16e2, 16f, 16g, 16h, and 16i. The connection conductors 16a, 16c, 16e1, 16f, and 16h are exposed to the side surface 11d. The connection conductors 16b, 16d, 16e2, 16g, and 16i are exposed to the side surface 11c.

The connection conductors 16a, 16b, 16c, and 16d are disposed on the piezoelectric layer 14b and the piezoelectric layer 14f. In the piezoelectric layer 14b and the piezoelectric layer 14f, the connection conductor 16a and the connection conductor 16c are exposed to the side surface 11d at different positions in the third direction D3, for example. The connection conductor 16b and the connection conductor 16d are exposed to the side surface 11c at different positions in the third direction D3, for example. The connection conductor 16a and the connection conductor 16d are exposed to corresponding side surface of the pair of side surfaces 11c and 11d at the same position in the third direction D3, for example. The connection conductor 16b and the connection conductor 16c are exposed to corresponding side surface of the pair of side surfaces 11c and 11d at the same position in the third direction D3, for example.

In the piezoelectric layer 14b and the piezoelectric layer 14f, the connection conductor 16a is connected to the internal electrode 12A. For example, the connection conductor 16a is connected to an edge of the internal electrode 12A closer to the side surface 11d, at a position closer to the end surface 11e in the third direction D3 of the internal electrode 12A. The connection conductor 16a and the internal electrode 12A are physically and electrically connected, for example.

In the piezoelectric layer 14b and the piezoelectric layer 14f, the connection conductor 16b is connected to the internal electrode 12B. For example, the connection conductor 16b is connected to an edge of the internal electrode 12B closer to the side surface 11c, at a position closer to the end surface 11f in the third direction D3 of the internal electrode 12B. The connection conductor 16b and the internal electrode 12B are physically and electrically connected, for example.

In the piezoelectric layer 14b and the piezoelectric layer 14f, the connection conductor 16c is connected to the internal electrode 12C. For example, the connection conductor 16c is connected to an edge of the internal electrode 12C closer to the side surface 11d, at a position closer to the end surface 11f in the third direction D3 of the internal electrode 12C. The connection conductor 16c and the internal electrode 12C are physically and electrically connected, for example.

In the piezoelectric layer 14b and the piezoelectric layer 14f, the connection conductor 16d is connected to the internal electrode 12D. For example, the connection conductor 16d is connected to an edge of the internal electrode 12D closer to the side surface 11c, at a position closer to the end surface 11e in the third direction D3 of the internal electrode 12D. The connection conductor 16d and the internal electrode 12D are physically and electrically connected, for example.

The connection conductors 16e1 and 16e2 are disposed on the piezoelectric layer 14c and the piezoelectric layer 14e. The connection conductor 16e1 and the connection conductor 16e2 are exposed to corresponding side surface of the pair of side surfaces 11c and 11d at the same position in the third direction D3, for example. In the piezoelectric layer 14c and the piezoelectric layer 14e, the connection conductors 16e1 and 16e2 are connected to the internal electrode 12E. For example, the connection conductor 16e1 is connected to an edge of the internal electrode 12E closer to the side surface 11d, at substantially the center of the internal electrode 12E in the third direction D3. For example, the connection conductor 16e2 is connected to an edge of the internal electrode 12E closer to the side surface 11c, at substantially the center of the internal electrode 12E in the third direction D3. The connection conductors 16e1 and 16e2 and the internal electrode 12E are physically and electrically connected, for example.

The connection conductors 16f, 16g, 16h, and 16i are disposed on the piezoelectric layer 14d. In the piezoelectric layer 14d, the connection conductor 16f and the connection conductor 16h are exposed to the side surface 11d at different positions in the third direction D3, for example. The connection conductor 16g and the connection conductor 16i are exposed to the side surface 11c at different positions in the third direction D3, for example. The connection conductor 16f and the connection conductor 16i are exposed to corresponding side surface of the pair of side surfaces 11c and 11d at the same position in the third direction D3, for example. The connection conductor 16h and the connection conductor 16g are exposed to corresponding side surface of the pair of side surfaces 11c and 11d at the same position in the third direction D3, for example.

In the piezoelectric layer 14d, the connection conductor 16f is connected to the internal electrode 12F. For example, the connection conductor 16f is connected to an edge of the internal electrode 12F closer to the side surface 11d, at a position closer to the end surface 11e in the third direction D3 of the internal electrode 12F. The connection conductor 16f and the internal electrode 12F are physically and electrically connected, for example.

In the piezoelectric layer 14d, the connection conductor 16g is connected to the internal electrode 12G. For example, the connection conductor 16g is connected to an edge of the internal electrode 12G closer to the side surface 11c, at a position closer to the end surface 11f in the third direction D3 of the internal electrode 12G. The connection conductor 16g and the internal electrode 12G are physically and electrically connected, for example.

In the piezoelectric layer 14d, the connection conductor 16h is connected to the internal electrode 12H. For example, the connection conductor 16h is connected to an edge of the internal electrode 12H closer to the side surface 11d, at a position closer to the end surface 11f in the third direction D3 of the internal electrode 12H. The connection conductor 16h and the internal electrode 12H are physically and electrically connected, for example.

In the piezoelectric layer 14d, the connection conductor 16i is connected to the internal electrode 12I. For example, the connection conductor 16i is connected to an edge of the internal electrode 12I closer to the side surface 11c, at a position closer to the end surface 11e in the third direction D3 of the internal electrode 12I. The connection conductor 16i and the internal electrode 12I are physically and electrically connected, for example.

As illustrated in FIGS. 4 and 5, the internal electrodes 12A and 12B and the internal electrodes 12C and 12D disposed on the piezoelectric layer 14b oppose the internal electrode 12E disposed on the piezoelectric layer 14c with a part of the piezoelectric body 11.

In the present embodiment, the internal electrode 12A and the internal electrode 12D disposed on the piezoelectric layer 14b oppose the internal electrode 12Ea disposed on the piezoelectric layer 14c with the piezoelectric layer. That is, in the piezoelectric layer 14b and the piezoelectric layer 14c, the internal electrode 12Ea includes a portion opposing the internal electrode 12A and a portion opposing the internal electrode 12D.

The internal electrode 12B and the internal electrode 12C disposed on the piezoelectric layer 14b oppose the internal electrode 12Eb disposed on the piezoelectric layer 14c with the piezoelectric layer. That is, in the piezoelectric layer 14b and the piezoelectric layer 14c, the internal electrode 12Eb includes a portion opposing the internal electrode 12B and a portion opposing the internal electrode 12C.

The internal electrode 12E disposed on the piezoelectric layer 14c opposes the internal electrodes 12F and 12G and the internal electrodes 12H and 12I disposed on the piezoelectric layer 14d with a part of the piezoelectric body 11.

In the present embodiment, the internal electrode 12Ea disposed on the piezoelectric layer 14c opposes the internal electrode 12F and the internal electrode 12I disposed on the piezoelectric layer 14d with the piezoelectric layer. That is, in the piezoelectric layer 14c and the piezoelectric layer 14d, the internal electrode 12Ea includes a portion opposing the internal electrode 12F and a portion opposing the internal electrode 12I.

The internal electrode 12Eb disposed on the piezoelectric layer 14c opposes the internal electrode 12G and the internal electrode 12H disposed on the piezoelectric layer 14d with the piezoelectric layer. That is, in the piezoelectric layer 14c and the piezoelectric layer 14d, the internal electrode 12Eb includes a portion opposing the internal electrode 12G and a portion opposing the internal electrode 12H.

The internal electrodes 12F and 12G and the internal electrodes 12H and 12I disposed on the piezoelectric layer 14d oppose the internal electrode 12E disposed on the piezoelectric layer 14e with a part of the piezoelectric body 11.

In the present embodiment, the internal electrode 12F and the internal electrode 12I disposed on the piezoelectric layer 14d oppose the internal electrode 12Ea disposed on the piezoelectric layer 14e with the piezoelectric layer. That is, in the piezoelectric layer 14d and the piezoelectric layer 14e, the internal electrode 12Ea includes a portion opposing the internal electrode 12F and a portion opposing the internal electrode 12I.

The internal electrode 12G and the internal electrode 12H disposed on the piezoelectric layer 14d oppose the internal electrode 12Eb disposed on the piezoelectric layer 14e with the piezoelectric layer. That is, in the piezoelectric layer 14d and the piezoelectric layer 14e, the internal electrode 12Eb includes a portion opposing the internal electrode 12G and a portion opposing the internal electrode 12H.

The internal electrode 12E disposed on the piezoelectric layer 14e opposes the internal electrodes 12A and 12B and the internal electrodes 12C and 12D disposed on the piezoelectric layer 14f with a part of the piezoelectric body 11.

In the present embodiment, the internal electrode 12Ea disposed on the piezoelectric layer 14e opposes the internal electrode 12A and the internal electrode 12D disposed on the piezoelectric layer 14f with the piezoelectric layer. That is, in the piezoelectric layer 14e and the piezoelectric layer 14f, the internal electrode 12Ea includes a portion opposing the internal electrode 12A and a portion opposing the internal electrode 12D.

The internal electrode 12Eb disposed on the piezoelectric layer 14e opposes the internal electrode 12B and the internal electrode 12C disposed on the piezoelectric layer 14f with the piezoelectric layer. That is, in the piezoelectric layer 14e and the piezoelectric layer 14f, the internal electrode 12Eb includes a portion opposing the internal electrode 12B and a portion opposing the internal electrode 12C.

The piezoelectric element 10 includes a portion P1 and a portion P2. The portion P1 and the portion P2 are arranged to include an active region that is piezoelectrically active in the piezoelectric element 10. That is, the portion P1 and the portion P2 include an active region that is piezoelectrically active in the piezoelectric element 10. In the present disclosure, being piezoelectrically active includes causing displacement through application of a voltage and generating a charge through the displacement. In the piezoelectric element 10, the portion P1 and the portion P2 are arranged to displace through the application of the voltage. Alternatively, the portion P1 and the portion P2 are arranged to generate an electric charge through the displacement. That is, in the piezoelectric element 10, the portion P1 and the portion P2 are displaced through the application of the voltage. Alternatively, the portion P1 and the portion P2 generate the electric charge through the displacement. The portion P1 and the portion P2 generate the voltage through the displacement, for example.

In the present embodiment, the portion P1 includes the internal electrode 12C, the portion of the internal electrode 12Eb opposing the internal electrode 12C, and the piezoelectric layer between the internal electrode 12C and the portion of the internal electrode 12Eb. In the portion P1, the active region includes the piezoelectric layer between the internal electrode 12C and the portion of the internal electrode 12Eb.

The portion P1 includes the internal electrode 12D, the portion of the internal electrode 12Ea opposing the internal electrode 12D, and the piezoelectric layer between the internal electrode 12D and the portion of the internal electrode 12Ea. In the portion P1, the active region includes the piezoelectric layer between the internal electrode 12D and the portion of the internal electrode 12Ea.

The portion P1 includes the internal electrode 12H, the portion of the internal electrode 12Eb opposing the internal electrode 12H, and the piezoelectric layer between the internal electrode 12H and the portion of the internal electrode 12Eb. In the portion P1, the active region includes the piezoelectric layer between the internal electrode 12H and the portion of the internal electrode 12Eb.

The portion P1 includes the internal electrode 12I, the portion of the internal electrode 12Ea opposing the internal electrode 12I, and the piezoelectric layer between the internal electrode 12I and the portion of the internal electrode 12Ea. In the portion P1, the active region includes the piezoelectric layer between the internal electrode 12I and the portion of the internal electrode 12Ea.

In the present embodiment, the portion P2 includes the internal electrode 12A, the portion of the internal electrode 12Ea opposing the internal electrode 12A, and the piezoelectric layer between the internal electrode 12A and the portion of the internal electrode 12Ea. In the portion P2, the active region includes the piezoelectric layer between the internal electrode 12A and the portion of the internal electrode 12Ea.

The portion P2 includes the internal electrode 12B, the portion of the internal electrode 12Eb opposing the internal electrode 12B, and the piezoelectric layer between the internal electrode 12B and the portion of the internal electrode 12Eb. In the portion P2, the active region includes the piezoelectric layer between the internal electrode 12B and the portion of the internal electrode 12Eb.

The portion P2 includes the internal electrode 12F, the portion of the internal electrode 12Ea opposing the internal electrode 12F, and the piezoelectric layer between the internal electrode 12F and the portion of the internal electrode 12Ea. In the portion P2, the active region includes the piezoelectric layer between the internal electrode 12F and the portion of the internal electrode 12Ea.

The portion P2 includes the internal electrode 12G, the portion of the internal electrode 12Eb opposing the internal electrode 12G, and the piezoelectric layer between the internal electrode 12G and the portion of the internal electrode 12Eb. In the portion P2, the active region includes the piezoelectric layer between the internal electrode 12G and the portion of the internal electrode 12Eb.

In the present embodiment, as illustrated in FIG. 2, the external electrode 13 includes a plurality of external electrodes 13A, 13B, 13C, 13D, 13E, and 13F. Each of the plurality of external electrodes 13A, 13B, 13C, 13D, 13E, and 13F has the rectangular shape, when viewed from the second direction D2. In the present embodiment, a longitudinal direction of each of the external electrodes 13A, 13B, 13C, 13D, 13E, and 13F includes the first direction D1, and a lateral direction of each of the external electrodes 13A, 13B, 13C, 13D, 13E, and 13F includes the third direction D3. The longitudinal direction of each of the external electrodes 13A, 13B, 13C, 13D, 13E, and 13F may include the third direction D3, and the lateral direction of each of the external electrodes 13A, 13B, 13C, 13D, 13E, and 13F may include the first direction D1.

The external electrodes 13A, 13B, and 13C are disposed on the side surface 11c. The external electrode 13A, the external electrode 13B, and the external electrode 13C are arranged in this order in the direction from the end surface 11e toward the end surface 11f in the third direction D3, for example. The external electrodes 13D, 13E, and 13F are disposed on the side surface 11d. For example, the external electrode 13D, the external electrode 13E, and the external electrode 13F are arranged in this order in the direction from the end surface 11e toward the end surface 11f in the third direction D3.

In the present embodiment, the external electrode 13A is connected to the connection conductors 16d disposed on the piezoelectric layer 14b and the piezoelectric layer 14f, and the connection conductor 16i disposed on the piezoelectric layer 14d. As a result, the external electrode 13A is electrically connected to the internal electrodes 12D disposed on the piezoelectric layer 14b and the piezoelectric layer 14f, and the internal electrode 12I disposed on the piezoelectric layer 14d.

The external electrode 13B is connected to the connection conductors 16e2 disposed on the piezoelectric layer 14c and the piezoelectric layer 14e. As a result, the external electrode 13B is electrically connected to the internal electrodes 12E disposed on the piezoelectric layer 14c and the piezoelectric layer 14e.

The external electrode 13C is connected to the connection conductors 16b disposed on the piezoelectric layer 14b and the piezoelectric layer 14f and the connection conductor 16g disposed on the piezoelectric layer 14d. As a result, the external electrode 13C is electrically connected to the internal electrodes 12B disposed on the piezoelectric layer 14b and the piezoelectric layer 14f, and the internal electrode 12G disposed on the piezoelectric layer 14d.

The external electrode 13D is connected to the connection conductors 16a disposed on the piezoelectric layer 14b and the piezoelectric layer 14f, and the connection conductor 16f disposed on the piezoelectric layer 14d. As a result, the external electrode 13D is electrically connected to the internal electrodes 12A disposed on the the piezoelectric layer 14b and the piezoelectric layer 14f, and the internal electrode 12F disposed on the piezoelectric layer 14d.

The external electrode 13E is connected to the connection conductors 16e1 disposed on the piezoelectric layer 14 c and the piezoelectric layer 14e. As a result, the external electrode 13E is electrically connected to the internal electrodes 12E disposed on the piezoelectric layer 14c and the piezoelectric layer 14e.

The external electrode 13F is connected to the connection conductors 16c disposed on the piezoelectric layer 14b and the piezoelectric layer 14f, and the connection conductor 16h disposed on the piezoelectric layer 14d. As a result, the external electrode 13F is electrically connected to the internal electrodes 12C disposed on the piezoelectric layer 14b and the piezoelectric layer 14f, and the internal electrode 12H disposed on the piezoelectric layer 14d.

The external electrode 13 includes, for example, a sintered metal layer. The sintered metal layer is formed through drying and baking an electrically conductive paste applied to the side surfaces 11c and 11d. The external electrode 13 is formed, for example, through sintering the metal powder contained in the electrically conductive paste. The sintered metal layer includes an electrically conductive material of a noble metal or a noble metal alloy. The noble metal includes, for example, Ag, Pd, Au, or Pt. The noble metal alloy includes, for example, an Ag—Pd alloy. The external electrode 13 may include a plating layer disposed on the sintered metal layer.

The amplifier 20 is arranged to amplify a voltage generated in the piezoelectric body 11. That is, the amplifier 20 amplifies a voltage generated in the piezoelectric body 11. The amplifier 20 is electrically connected to the piezoelectric element 10. The amplifier 20 is electrically connected to the external electrode 13C of the piezoelectric element 10 by, for example, a wiring member (not illustrated). In the present embodiment, the amplifier 20 amplifies the voltage generated in the portion P2 of the piezoelectric body 11. The operation section OU outputs the voltage amplified by the amplifier 20 as a signal responding to the electric charge generated in the portion P2. In the present embodiment, the operation section OU outputs a voltage signal as the signal responding to the electric charge generated in the portion P2. The voltage signal is, for example, an analog signal. The voltage signal output from the operation section OU is input to the controller CU. The amplifier 20 is known in the art and further detailed description is omitted.

Here, the displacement of the portion P2 changes responding to a force that the piezoelectric element 10 receives from the operation body. For example, as the force that the piezoelectric element 10 receives from the operation body increases, the portion P2 is restrained by the force, and thus tends not to be displaced. That is, in the piezoelectric element 10, ease of the displacement of the portion P2 changes responding to the force that the piezoelectric element 10 receives from the operation body. Therefore, the voltage signal output from the operation section OU also changes responding to the force that the piezoelectric element 10 receives from the operation body. For example, the voltage signal decreases as the force that the piezoelectric element 10 receives from the operation body increases.

The controller CU includes, for example, a computer system. The computer system physically includes, for example, a processor (arithmetic circuit), a memory, a communication interface, and a storage. The memory includes, for example, a read only memory (ROM) and a random access memory (RAM). The storage includes, for example, a hard disk drive (HDD) or a solid state drive (SSD). The controller CU may include, for example, a microcontroller or an integrated circuit.

The controller CU is arranged to apply a voltage to the piezoelectric element 10 and acquire information regarding the force that the piezoelectric element 10 receives from the operation body. That is, the controller CU applies a voltage to the piezoelectric element 10 and acquires information regarding the force that the piezoelectric element 10 receives from the operation body. The controller CU acquires the information regarding the force that the piezoelectric element 10 receives from the operation body, for example, by executing a program stored in the memory by the CPU. With this processing, the controller CU includes the functional elements illustrated in FIG. 3. That is, the controller CU includes an oscillator 30, a converter 40, and a processor 50.

The oscillator 30 is electrically connected to the piezoelectric element 10, and applies the voltage to the piezoelectric element 10. The oscillator 30 is electrically connected to the piezoelectric element 10 by, for example, a wiring member (not illustrated). In the present embodiment, the oscillator 30 is electrically connected to the external electrode 13A of the piezoelectric element 10. The oscillator 30 applies the voltage to the portion P1 via the external electrode 13A, for example. In the present embodiment, the oscillator 30 applies the voltage to the internal electrode 12C and the internal electrode 12E, the internal electrode 12D and the internal electrode 12E, the internal electrode 12H and the internal electrode 12E, and the internal electrode 12I and the internal electrode 12E. That is, in the present embodiment, the controller CU applies the voltage to the portion P1.

As described above, in the present embodiment, the oscillator 30 is electrically connected to the external electrode 13A, and the amplifier 20 is electrically connected to the external electrode 13C. In this configuration, for example, the oscillator 30 is also connected to the external electrode 13B. That is, in the present embodiment, the portion P1 is displaced through the voltage applied from the controller CU. The displacement of the portion P1 is transmitted to the portion P2, and the portion P2 is displaced. The portion P2 generates the electric charge through the displacement. In the present embodiment, the portion P2 generates the voltage through displacement. Therefore, in the present embodiment, the operation section OU is arranged to output a signal responding to the electric charge generated in the portion P2. That is, in the present embodiment, the operation section OU outputs the signal responding to the electric charge generated in the portion P2. Hereinafter, a configuration in which the portion P1 is displaced through the application of the voltage and the portion P2 generates the electric charge through the displacement will be described as an example.

The converter 40 is arranged to convert a signal output from the operation section OU into a digital signal. That is, the converter 40 converts a signal output from the operation section OU into a digital signal. The converter 40 is electrically connected to the amplifier 20, for example, and converts the voltage signal output as the analog signal from the amplifier 20 into the digital signal. The converter 40 includes, for example, a rectifier and an A/D converter. The converter 40 outputs the converted digital signal to the processor 50. The oscillator 30 and the converter 40 are known in the art, and further detailed description will be omitted.

In the present embodiment, the piezoelectric element 10, the amplifier 20, the oscillator 30, and the converter 40 are connected as illustrated in FIG. 6. In the example illustrated in FIG. 6, the amplifier 20 includes a differential amplifier circuit 21. The oscillator 30 includes a capacitor 31, a resistor 32, an inverter 33, a resistor 34, and a capacitor 35. The oscillator 30 may include a NAND circuit instead of the inverter 33. The converter 40 includes a diode 41, a capacitor 42, and a resistor 43.

In the example illustrated in FIG. 6, one end of the portion P1 is connected to an input end of the inverter 33, and the other end of the portion P1 is connected to an output end of the inverter 33 via the resistor 34. In the present embodiment, the input end of the inverter 33 is connected to the external electrode 13B. The input end of the inverter 33 and the portion P1 are connected to each other via the external electrode 13B. Furthermore, the input end and the output end of the inverter 33 are connected via the resistor 32. One ends of the portions P1 and P2 are grounded via the capacitor 31, and the other end of the portion P1 is grounded via the capacitor 35. The other end of the portion P2 is connected to a non-inverting input terminal of the differential amplifier circuit 21. The voltage generated in the portion P2 is input to the non-inverting input terminal of the differential amplifier circuit 21. An inverting input terminal of the differential amplifier circuit 21 is grounded via the capacitor 31. An output terminal of the differential amplifier circuit 21 is connected to an input terminal of the diode 41.

The differential amplifier circuit 21 amplifies the input voltage generated in the portion P2 and outputs the amplified voltage to the diode 41. The differential amplifier circuit 21 outputs, for example, an AC voltage signal to the diode 41. The diode 41 converts the AC voltage signal output from the differential amplifier circuit 21 into a half-wave rectified signal. An output terminal of the diode 41 is connected to the capacitor 42 and the resistor 43. The capacitor 42 smooths the half-wave rectified signal output from the output terminal of the diode 41. The resistor 43 is used to discharge the electric charge accumulated in the capacitor 42. As described above, in the example illustrated in FIG. 6, the voltage signal responding to the electric charge generated in the portion P2 is amplified by the differential amplifier circuit 21, and the amplified voltage signal is converted into the half-wave rectified signal by the diode 41. Then, the converted half-wave rectified signal is smoothed by the capacitor 42, and the smoothed half-wave rectified signal is output to the A/D converter included in the converter 40.

The processor 50 is arranged to acquire the information regarding the force received from the operation body based on the signal output from the operation section OU. That is, the processor 50 acquires the information regarding the force received from the operation body based on the signal output from the operation section OU. First, the processor 50 acquires the digital signal output from the converter 40. That is, the processor 50 acquires voltage data obtained through converting the voltage signal responding to the electric charge generated in the portion P2 into digital data. The voltage data includes, for example, a value based on the signal output from the operation section OU. That is, the voltage data includes, for example, a value based on the signal responding to the electric charge generated in the portion P2.

Next, the processor 50 performs a comparison of the value based on the signal output from the operation section OU included in the acquired voltage data with a reference value. That is, the processor 50 is arranged to perform the comparison of the value based on the signal output from the operation section OU included in the acquired voltage data with the reference value. In the present embodiment, the processor 50 obtains a difference between the value based on the signal output from the operation section OU and the reference value as the comparison between the value based on the signal output from the operation section OU and the reference value. The reference value is, for example, a value based on a signal output from the operation section OU in a state where the piezoelectric element 10 receives a predetermined force from the operation body. In the present embodiment, the predetermined force is zero. In the present embodiment, the reference value is a value based on a signal output from the operation section OU in an initial state where no force is received from the operation body. That is, in the present embodiment, the controller CU is arranged to perform a comparison of the value based on the signal output from the operation section OU with the reference value that is based on the signal output from the operation section OU in the initial state where no force is received from the operation body. The predetermined force may be greater than zero.

The reference value may be stored in the storage included in the computer system configuring the controller CU. Alternatively, every time the processor 50 receives the signal from the operation section OU, the processor 50 may access a given database or file system to acquire the reference value. Alternatively, the processor 50 may acquire the reference value input to the controller CU by a user.

Next, the processor 50 acquires the information regarding the force received from the operation body based on the result of the comparison. In the present embodiment, the processor 50 acquires the information regarding the force received from the operation body based on the difference between the value based on the signal output from the operation section OU and the reference value. For example, the processor 50 refers to information indicating a relationship between the difference and a value based on a magnitude of the force received from the operation body, and acquires a value corresponding to the calculated difference. Then, the processor 50 acquires the acquired value based on the magnitude of the force received from the operation body, as the information regarding the force received from the operation body. That is, in the present embodiment, the information regarding the force received from the operation body includes information regarding the magnitude of the force. The processor 50 may output the acquired information regarding the force received from the operation body to a display device (not illustrated).

The information regarding the force received from the operation body may include, for example, information regarding the presence or absence of the force. In this configuration, for example, in a case where the difference between the value based on the signal output from the operation section OU and the reference value is equal to or less than a predetermined threshold value, the processor 50 acquires information that the difference is equal to or less than the predetermined threshold value as information indicating that there is no force received from the operation body. In a case where the difference between the value based on the signal output from the operation section OU and the reference value is larger than the predetermined threshold value, the processor 50 may acquire information that the difference is larger than the predetermined threshold value as information indicating that there is a force received from the operation body.

As described above, in the input device ID, the operation section OU includes the piezoelectric element 10 arranged to receive the force from the operation body, and including one piezoelectric body including the portion P1 and the portion P2. The portion P1 is arranged to be displaced through application of the voltage. The portion P2 is arranged to generate the electric charge through the displacement. In a case where the portion P1 is displaced in the piezoelectric body 11, the displacement of the portion P1 is transmitted to the portion P2, and the portion P2 is displaced. When receiving the force on the piezoelectric element 10 from the operation body, a restraint force responding to the force acts on the piezoelectric body 11 including the portion P1 and the portion P2. Therefore, the force received on the piezoelectric element 10 from the operation body affects the ease of the displacement of the portion P2. That is, when receiving the force on the piezoelectric element 10 from the operation body, the displacement of the portion P2 changes responding to the force. As the displacement of the portion P2 changes, the electric charge generated in the portion P2 also changes.

As described above, in the input device ID, the portion P2 is displaced through the transmission of the displacement of the portion P1, and the displacement of the portion P2 changes responding to the force received from the operation body. However, in a configuration in which the displacement of the portion P1 is not appropriately transmitted to the portion P2, there is a possibility that the displacement of the portion P2 does not change responding to the force received from the operation body. That is, the ease of transmission of the displacement between the portion P1 and the portion P2 affects the accuracy of the information regarding the force received from the operation body. In the input device ID, since the portion P1 and the portion P2 are included in the piezoelectric body 11, the displacement of the portion P1 is easily transmitted to the portion P2 as compared with a configuration in which the portion P1 and the portion P2 are included in separate piezoelectric bodies.

As described above, the input device ID improves the accuracy of the information regarding the force received from the operation body.

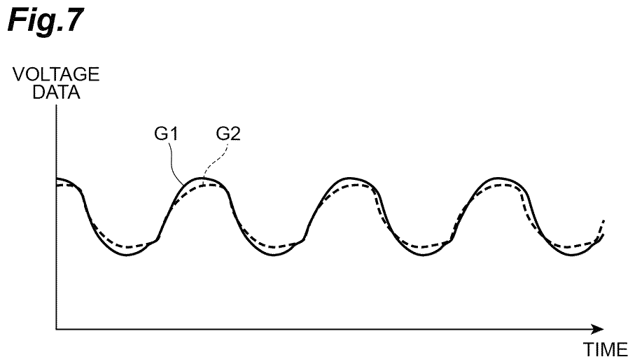

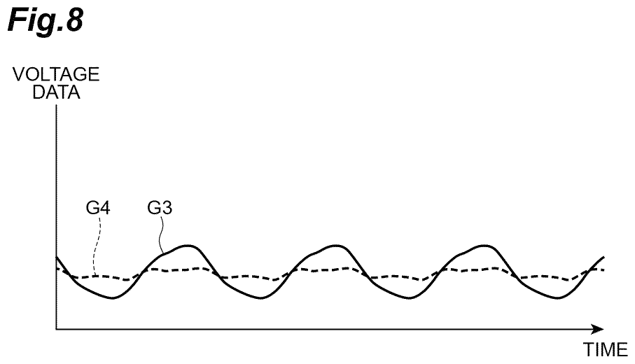

Here, an example of the voltage data acquired by the processor 50 will be described with reference to FIGS. 7 and 8. FIG. 7 is a diagram illustrating an example of control processing in the input device, and is a diagram illustrating an example of voltage data regarding a voltage applied to the portion P1. FIG. 8 is a diagram illustrating an example of control processing in the input device, and is a diagram illustrating an example of voltage data acquired by the processor 50. In the graphs illustrated in FIGS. 7 and 8, a horizontal axis indicates time and a vertical axis indicates voltage data.

In FIG. 7, a change G1 is a graph illustrating voltage data regarding the voltage applied to the portion P1 in the initial state where the piezoelectric element 10 receives no force from the operation body. A change G2 is a graph illustrating voltage data regarding the voltage applied to the portion P1 in a state where the piezoelectric element 10 receives a constant force from the operation body. Comparing the change G1 and the change G2, it can be seen that there is a difference between the voltage data in the change G1 and the voltage data in the change G2 at a plurality of time points, but there is no large difference between an outline of the change G1 and an outline of the change G2. That is, as can be seen from FIG. 7, even in the case where the piezoelectric element 10 receives the force from the operation body, a change tends not to occurs in the voltage data regarding the voltage applied to the portion P1.

In FIG. 8, a change G3 is a graph illustrating voltage data acquired by the processor 50 in the initial state where the piezoelectric element 10 receives no force from the operation body. A change G4 is a graph illustrating voltage data acquired by the processor 50 in a state where the piezoelectric element 10 receives a constant force from the operation body. Comparing the change G3 and the change G4, it can be seen that an outline of the change G3 and an outline of the change G4 are different from each other, and the voltage data in the change G4 has a smaller change than the voltage data in the change G3. That is, it can be seen from FIG. 8 that the change in the voltage data acquired by the processor 50 is reduced through the piezoelectric element 10 receiving the force from the operation body. The difference between the change G1 and the change G2 is caused by, as described above, the fact that the piezoelectric element 10 receives the force from the operation body, whereby the restraint force acts on the piezoelectric body 11, and the ease of displacement of the portion P2 changes.

In the input device ID, the controller CU is arranged to perform the comparison of the value based on the signal output from the operation section OU with the reference value, and acquire the information regarding the force received from the operation body based on the result of the comparison.

The controller CU is arranged to perform the comparison of the value based on the signal output from the operation section OU with the reference value, whereby the controller CU accurately captures a change in the force that the piezoelectric element 10 receives from the operation body. Therefore, the input device ID further improves the accuracy of the information regarding the force received from the operation body.

In the input device ID, the controller CU is arranged to perform the comparison of the value based on the signal output from the operation section OU with the reference value that is based on the signal output from the operation section OU in the initial state where the piezoelectric element 10 receives no force from the operation body.

By using the initial state as a reference, the controller CU can more accurately capture the change in the force that the piezoelectric element 10 receives from the operation body. Therefore, the input device ID more reliably improves the accuracy of the information regarding the force received from the operation body.

In the input device ID, the controller CU is arranged to acquire the information regarding the force that the piezoelectric element 10 receives from the operation body based on the difference between the value based on the signal output from the operation section OU and the reference value.

The difference between the value based on the signal output from the operation section OU and the reference value indicates an amount of the change from the reference value. Based on the amount of the change from the reference value, the controller CU more reliably and accurately captures the change in the force that the piezoelectric element 10 receives from the operation body. Therefore, the input device ID can more reliably improve the accuracy of the information regarding the force received from the operation body.

The force that the piezoelectric element 10 receives from the operation body includes a force whose magnitude does not change with the lapse of time. Hereinafter, a force whose magnitude does not change with the lapse of time may be referred to as a “static load”. In the ideal state, the piezoelectric ceramic material is completely an electrical insulator. However, since the actual piezoelectric ceramic material has a finite insulation resistance, in a case where the piezoelectric element 10 receives the static load from the operation body, the electric charge generated through the portion P2 is discharged with the lapse of time. As described above, there is the difference in voltage data, which are the signal output from the operation section OU, between the initial state where the piezoelectric element 10 receives no force from the operation body and the state where the piezoelectric element 10 receives the constant force from the operation body. That is, the static load that the piezoelectric element 10 receives from the operation body is detected through using the voltage data as the signal output from the operation section OU. Therefore, even in the case where the force that the piezoelectric element 10 receives from the operation body is the static load, the input device ID can acquire information regarding the force.

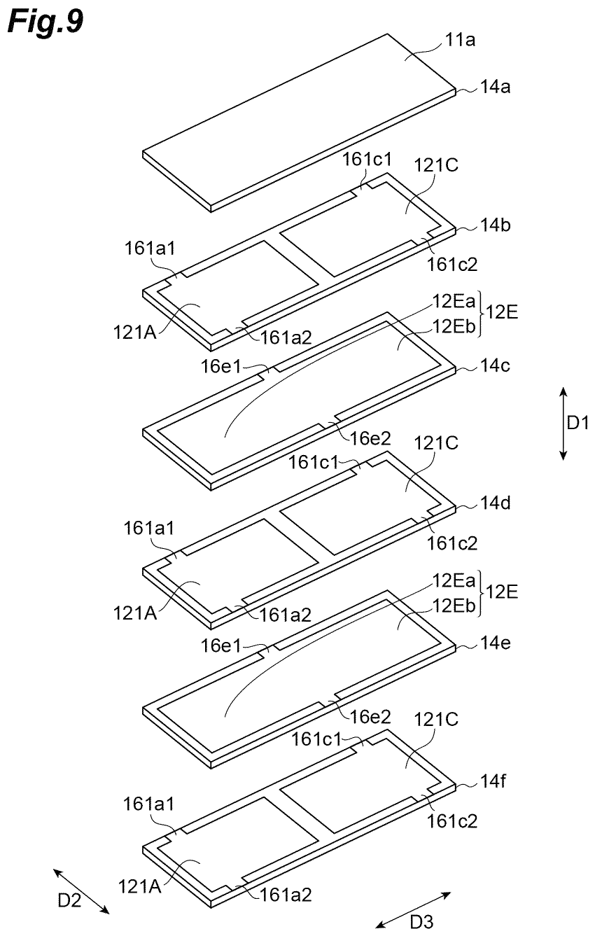

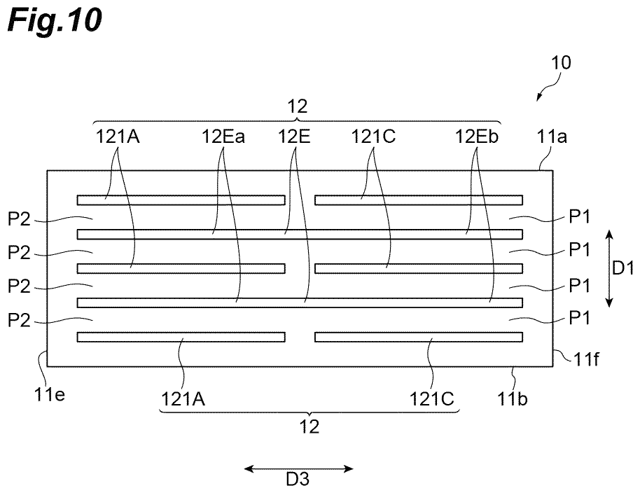

Next, a configuration of a first modification of the input device ID according to the present embodiment will be described with reference to FIGS. 9 and 10. FIG. 9 is an exploded perspective diagram of a piezoelectric element. FIG. 10 is a diagram illustrating a cross-sectional configuration of the piezoelectric element. In FIG. 10, hatching is omitted to clearly illustrate each part. In the present modification, the configuration of the internal electrode 12 is different from that of the above-described embodiment. Hereinafter, differences between the above-described embodiment and the present modification will be mainly described.

As illustrated in FIG. 9, in the present modification, the internal electrode 12 includes a plurality of internal electrodes 121A, a plurality of internal electrodes 121C, and a plurality of internal electrodes 12E. Each of the internal electrodes 121A and 121C has a rectangular shape. That is, in the present modification, the piezoelectric element 10 includes the plurality of internal electrodes 121A, 121C, and 12E.

The internal electrode 121A and the internal electrode 121C are disposed on the piezoelectric layer 14b, the piezoelectric layer 14d, and the piezoelectric layer 14f. The internal electrode 121A is disposed closer to the end surface 11e than the center of the piezoelectric layers 14b, 14d, and 14f in the third direction D3, when viewed from the first direction D1. The internal electrode 121C is disposed closer to the end surface 11f than the center of the piezoelectric layers 14b, 14d, and 14f in the third direction D3, when viewed from the first direction D1. On the piezoelectric layer 14b, the piezoelectric layer 14d, and the piezoelectric layer 14f, the internal electrode 121A and the internal electrode 121C are separated from each other.

In the present modification, the piezoelectric body 11 includes connection conductors 161a1, 161a2, 161c1, 161c2, 16e1, and 16e2. The connection conductors 161a1, 161c1, and 16e1 are exposed to the side surface 11d. The connection conductors 161a2, 161c2, and 16e2 are exposed to the side surface 11c.

The connection conductors 161a1, 161a2, 161c1, and 161c2 are disposed on the piezoelectric layer 14b, the piezoelectric layer 14d, and the piezoelectric layer 14f. In the piezoelectric layers 14b, 14d, and 14f, the connection conductor 161a1 and the connection conductor 161c1 are exposed to the side surface 11d at different positions in the third direction D3, for example. The connection conductor 161a2 and the connection conductor 161c2 are exposed to the side surface 11c at different positions in the third direction D3, for example. Each of the connection conductor 161a1 and the connection conductor 161a2 is exposed to corresponding side surface of the pair of side surfaces 11c and 11d at the same position in the third direction D3, for example. Each of the connection conductor 161c1 and the connection conductor 161c2 is exposed to corresponding side surface of the pair of side surface 11c and 11d at the same position in the third direction D3, for example.

In the piezoelectric layers 14b, 14d, and 14f, the connection conductors 161a1 and 161a2 are connected to the internal electrode 121A. For example, the connection conductor 161a1 is connected to an edge of the internal electrode 121A closer to the side surface 11d, at a position closer to the end surface 11e in the third direction D3 of the internal electrode 121A. For example, the connection conductor 161a2 is connected to an edge of the internal electrode 121A closer to the side surface 11c, at a position closer to the end surface 11e in the third direction D3 of the internal electrode 121A. The connection conductors 161a1 and 161a2 and the internal electrode 121A are physically and electrically connected, for example.

In the piezoelectric layers 14b, 14d, and 14f, the connection conductors 161c1 and 161c2 are connected to the internal electrode 121C. For example, the connection conductor 161c1 is connected to an edge of the internal electrode 121C closer to the side surface 11d, at a position closer to the end surface 11f in the third direction D3 of the internal electrode 121C. For example, the connection conductor 161c2 is connected to an edge of the internal electrode 121C closer to the side surface 11c, at a position closer to the end surface 11f in the third direction D3 of the internal electrode 121C. The connection conductors 161c1 and 161c2 and the internal electrode 121C are physically and electrically connected, for example.

As illustrated in FIG. 10, the internal electrode 121A and the internal electrode 121C disposed on the piezoelectric layer 14b oppose the internal electrode 12E disposed on the piezoelectric layer 14c with the part of the piezoelectric body 11. In the present modification, the internal electrode 121A disposed on the piezoelectric layer 14b opposes the internal electrode 12Ea disposed on the piezoelectric layer 14c with the piezoelectric layer. The internal electrode 121C disposed on the piezoelectric layer 14b opposes the internal electrode 12Eb disposed on the piezoelectric layer 14c with the piezoelectric layer.

The internal electrode 12E disposed on the piezoelectric layer 14c opposes the internal electrode 121A and the internal electrode 121C disposed on the piezoelectric layer 14d with the part of the piezoelectric body 11. In the present modification, the internal electrode 12Ea disposed on the piezoelectric layer 14c opposes the internal electrode 121A disposed on the piezoelectric layer 14d with the piezoelectric layer. The internal electrode 12Eb disposed on the piezoelectric layer 14c opposes the internal electrode 121C disposed on the piezoelectric layer 14d with the piezoelectric layer.

The internal electrodes 121A and 121C disposed on the piezoelectric layer 14d oppose the internal electrode 12E disposed on the piezoelectric layer 14e with the part of the piezoelectric body 11. In the present modification, the internal electrode 121A disposed on the piezoelectric layer 14d opposes the internal electrode 12Ea disposed on the piezoelectric layer 14e with the piezoelectric layer. The internal electrode 121C disposed on the piezoelectric layer 14d opposes the internal electrode 12Eb disposed on the piezoelectric layer 14e with the piezoelectric layer.

The internal electrode 12E disposed on the piezoelectric layer 14e opposes the internal electrode 121A and the internal electrode 121C disposed on the piezoelectric layer 14f with the part of the piezoelectric body 11. In the present modification, the internal electrode 12Ea disposed on the piezoelectric layer 14e opposes the internal electrode 121A disposed on the piezoelectric layer 14f with the piezoelectric layer. The internal electrode 12Eb disposed on the piezoelectric layer 14e opposes the internal electrode 121C disposed on the piezoelectric layer 14f with the piezoelectric layer.

In the present modification, the portion P1 includes the internal electrode 121C, the internal electrode 12Eb, and the piezoelectric layer between the internal electrode 121C and the internal electrode 12Eb. In the portion P1, the active region includes the piezoelectric layer between the internal electrode 121C and the internal electrode 12Eb.

In the present modification, the portion P2 includes the internal electrode 121A, the internal electrode 12Ea, and the piezoelectric layer between the internal electrode 121A and the internal electrode 12Ea. In the portion P2, the active region includes the piezoelectric layer between the internal electrode 121A and the internal electrode 12Ea.

In the present modification, the external electrode 13A is connected to the connection conductors 161a2 disposed on the piezoelectric layer 14b, the piezoelectric layer 14d, and the piezoelectric layer 14f. As a result, the external electrode 13A is electrically connected to the internal electrodes 121A disposed on the piezoelectric layer 14b, the piezoelectric layer 14d, and the piezoelectric layer 14f.

The external electrode 13B is connected to the connection conductors 16e2 disposed on the piezoelectric layer 14c and the piezoelectric layer 14e. As a result, the external electrode 13B is electrically connected to the internal electrodes 12E disposed on the piezoelectric layer 14c and the piezoelectric layer 14e.

The external electrode 13C is connected to the connection conductors 161c2 disposed on the piezoelectric layer 14b, the piezoelectric layer 14d, and the piezoelectric layer 14f. As a result, the external electrode 13C is electrically connected to the internal electrodes 121C disposed on the piezoelectric layer 14b, the piezoelectric layer 14d, and the piezoelectric layer 14f.

The external electrode 13D is connected to the connection conductors 161a1 disposed on the piezoelectric layer 14b, the piezoelectric layer 14d, and the piezoelectric layer 14f. As a result, the external electrode 13D is electrically connected to the internal electrodes 121A disposed on the piezoelectric layer 14b, the piezoelectric layer 14d, and the piezoelectric layer 14f.

The external electrode 13E is connected to the connection conductors 16e1 disposed on the piezoelectric layer 14c and the piezoelectric layer 14e. As a result, the external electrode 13E is electrically connected to the internal electrodes 12E disposed on the piezoelectric layer 14c and the piezoelectric layer 14e.

The external electrode 13F is connected to the connection conductors 161c1 disposed on the piezoelectric layer 14b, the piezoelectric layer 14d, and the piezoelectric layer 14f. As a result, the external electrode 13F is electrically connected to the internal electrodes 121C disposed on the piezoelectric layer 14b, the piezoelectric layer 14d, and the piezoelectric layer 14f.

In the present modification, the amplifier 20 is electrically connected to the external electrode 13A. The oscillator 30 is electrically connected to the external electrode 13C. In the present modification, the oscillator 30 is also electrically connected to the external electrode 13B. As a result, the oscillator 30 applies a voltage to the portion P1. In the present modification, the oscillator 30 applies a voltage to the internal electrode 121C and the internal electrode 12E.

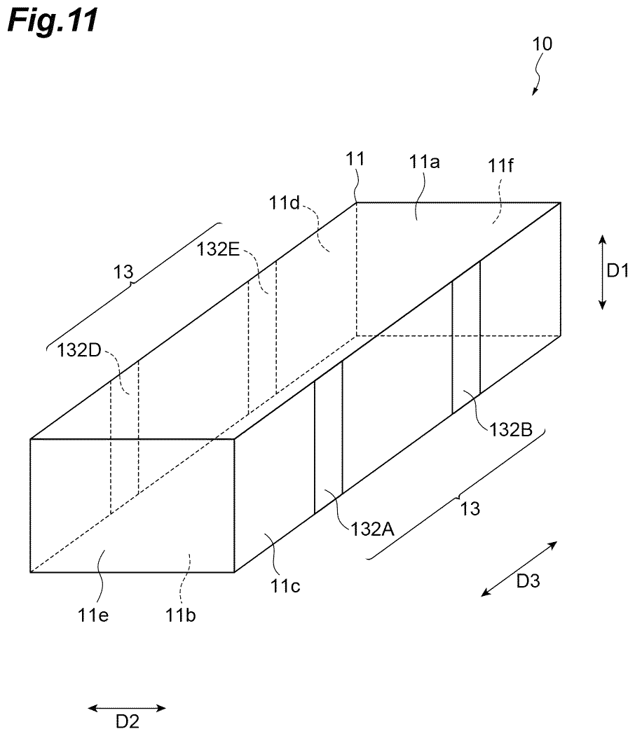

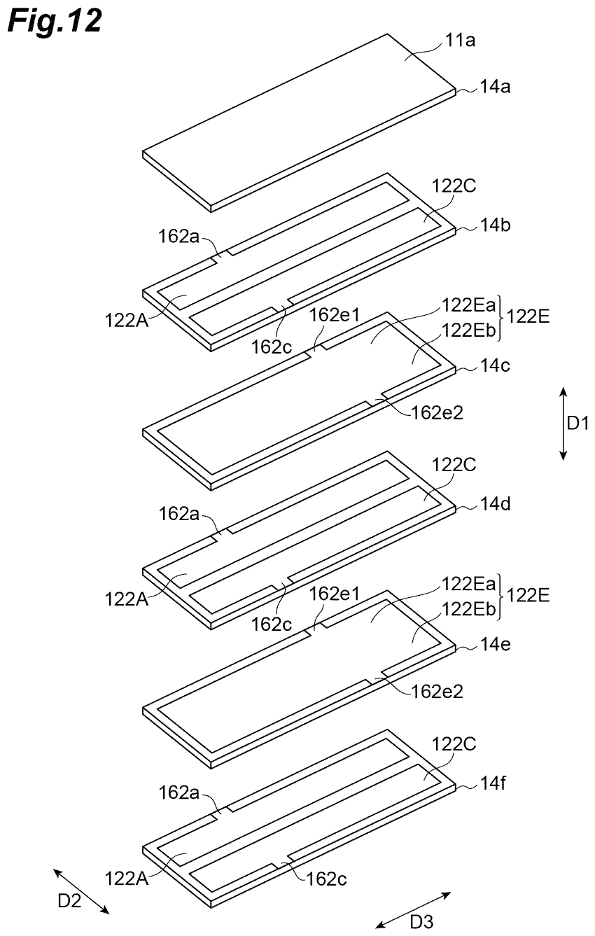

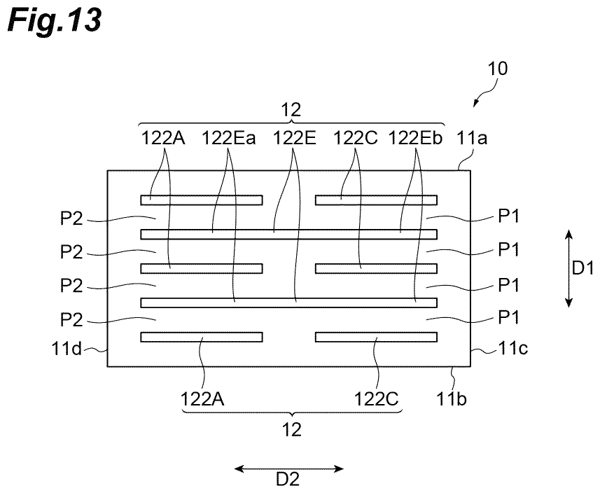

Next, a configuration of a second modification of the input device ID according to the present embodiment will be described with reference to FIGS. 11, 12, and 13. FIG. 11 is a perspective diagram of a piezoelectric element. FIG. 12 is an exploded perspective diagram of the piezoelectric element. FIG. 13 is a diagram illustrating a cross-sectional configuration of the piezoelectric element. In FIG. 13, hatching is omitted to clearly illustrate each part. In the present modification, the configurations of the internal electrode 12 and the external electrode 13 are different from those of the above-described embodiment. Hereinafter, differences between the above-described embodiment and the present modification will be mainly described.

As illustrated in FIG. 12, in the present modification, the internal electrode 12 includes a plurality of internal electrodes 122A, a plurality of internal electrodes 122C, and a plurality of internal electrodes 122E. Each of the internal electrodes 122A, 122C, and 122E has the rectangular shape. That is, in the present modification, the piezoelectric element 10 includes the plurality of internal electrodes 122A, 122C, and 122E.

The internal electrode 122A and the internal electrode 122C are disposed on the piezoelectric layer 14b, the piezoelectric layer 14d, and the piezoelectric layer 14f. The internal electrode 122A is disposed closer to the side surface 11d than the center of each of the piezoelectric layers 14b, 14d, and 14f in the second direction D2, when viewed from the first direction D1. The internal electrode 122C is disposed closer to the side surface 11c than the center of each of the piezoelectric layers 14b, 14d, and 14f in the second direction D2, when viewed from the first direction D1. On the piezoelectric layer 14b, the piezoelectric layer 14d, and the piezoelectric layer 14f, the internal electrode 122A and the internal electrode 122C are separated from each other.

The internal electrode 122E is disposed on the piezoelectric layer 14c and the piezoelectric layer 14e. The internal electrode 122E has, for example, a rectangular shape. In the present embodiment, the internal electrode 122E has a rectangular shape slightly smaller than the piezoelectric body 11, when viewed from the first direction D1. In the present modification, the internal electrode 122E includes an internal electrode 122Ea and an internal electrode 122Eb. The internal electrode 122Ea is disposed closer to the side surface 11d than the center of each of the piezoelectric layers 14c and 14e in the second direction D2, when viewed from the first direction D1. The internal electrode 122Eb is disposed closer to the side surface 11c than the center of each of the piezoelectric layers 14c and 14e in the second direction D2, when viewed from the first direction D1. In the present modification, the internal electrode 122Ea and the internal electrode 122Eb are integrated.

In the present modification, the piezoelectric body 11 includes connection conductors 162a, 162c, 162e1, and 162e2. The connection conductors 162a and 162e1 are exposed to the side surface 11d. The connection conductors 162c and 162e2 are exposed to the side surface 11c.

The connection conductors 162a and 162c are disposed on the piezoelectric layer 14b, the piezoelectric layer 14d, and the piezoelectric layer 14f. In the piezoelectric layers 14b, 14d, and 14f, the connection conductor 162a and the connection conductor 162c are exposed to corresponding side surfaces of the pair of side surfaces 11c and 11d at the same position in the third direction D3, for example.

The connection conductors 162e1 and 162e2 are disposed on the piezoelectric layer 14c and the piezoelectric layer 14e. In the piezoelectric layers 14c and 14e, the connection conductor 162e1 and the connection conductor 162e2 are exposed to corresponding side surfaces of the pair of side surfaces 11c and 11d at the same position in the third direction D3, for example.

In the piezoelectric layers 14b, 14d, and 14f and the piezoelectric layers 14c and 14e, the connection conductor 162a and the connection conductor 162e1 are exposed to the side surface 11d at different positions in the third direction D3, for example. In the piezoelectric layers 14b, 14d, and 14f and the piezoelectric layers 14c and 14e, the connection conductor 162c and the connection conductor 162e2 are exposed to the side surface 11c at different positions in the third direction D3, for example.

In the piezoelectric layers 14b, 14d, and 14f, the connection conductor 162a is connected to the internal electrode 122A. For example, the connection conductor 162a is connected to an edge of the internal electrode 122A closer to the side surface 11d, at a position closer to the end surface 11e in the third direction D3 of the internal electrode 122A. The connection conductor 162a and the internal electrode 122A are physically and electrically connected, for example.

In the piezoelectric layers 14b, 14d, and 14f, the connection conductor 162c is connected to the internal electrode 122C. For example, the connection conductor 162c is connected to an edge of the internal electrode 122C closer to the side surface 11c, at a position closer to the end surface 11e in the third direction D3 of the internal electrode 122C. The connection conductor 162c and the internal electrode 122C are physically and electrically connected, for example.

In the piezoelectric layers 14c and 14e, the connection conductor 162e1 is connected to the internal electrode 122E. For example, the connection conductor 162e1 is connected to an edge of the internal electrode 122Ea closer to the side surface 11d, at a position closer to the end surface 11f in the third direction D3 of the internal electrode 122E. The connection conductor 162e1 and the internal electrode 122Ea are physically and electrically connected, for example.

In the piezoelectric layers 14c and 14e, the connection conductor 162e2 is connected to the internal electrode 122E. For example, the connection conductor 162e2 is connected to an edge of the internal electrode 122Eb closer to the side surface 11c, at a position closer to the end surface 11f in the third direction D3 of the internal electrode 122E. The connection conductor 162e2 and the internal electrode 122Eb are physically and electrically connected, for example.

As illustrated in FIG. 13, the internal electrode 122A and the internal electrode 122C disposed on the piezoelectric layer 14b oppose the internal electrode 122E disposed on the piezoelectric layer 14c with the part of the piezoelectric body 11. In the present modification, the internal electrode 122A disposed on the piezoelectric layer 14b opposes the internal electrode 122Ea disposed on the piezoelectric layer 14c with the piezoelectric layer. The internal electrode 122C disposed on the piezoelectric layer 14b opposes the internal electrode 122Eb disposed on the piezoelectric layer 14c with the piezoelectric layer.

The internal electrode 122E disposed on the piezoelectric layer 14c opposes the internal electrode 122A and the internal electrode 122C disposed on the piezoelectric layer 14d with the part of the piezoelectric body 11. In the present modification, the internal electrode 122Ea disposed on the piezoelectric layer 14c opposes the internal electrode 122A disposed on the piezoelectric layer 14d with the piezoelectric layer. The internal electrode 122Eb disposed on the piezoelectric layer 14c opposes the internal electrode 122C disposed on the piezoelectric layer 14d with the piezoelectric layer.

The internal electrodes 122A and 122C disposed on the piezoelectric layer 14d oppose the internal electrode 122E disposed on the piezoelectric layer 14e with the part of the piezoelectric body 11. In the present modification, the internal electrode 122A disposed on the piezoelectric layer 14d opposes the internal electrode 122Ea disposed on the piezoelectric layer 14e with the piezoelectric layer. The internal electrode 122C disposed on the piezoelectric layer 14d opposes the internal electrode 122Eb disposed on the piezoelectric layer 14e with the piezoelectric layer.

The internal electrode 122E disposed on the piezoelectric layer 14e opposes the internal electrode 122A and the internal electrode 122C disposed on the piezoelectric layer 14f with the part of the piezoelectric body 11. In the present modification, the internal electrode 122Ea disposed on the piezoelectric layer 14e opposes the internal electrode 122A disposed on the piezoelectric layer 14f with the piezoelectric layer. The internal electrode 122Eb disposed on the piezoelectric layer 14e opposes the internal electrode 122C disposed on the piezoelectric layer 14f with the piezoelectric layer.

In the present modification, the portion P1 includes the internal electrode 122C, the internal electrode 122Eb, and the piezoelectric layer between the internal electrode 122C and the internal electrode 122Eb. In the portion P1, the active region includes the piezoelectric layer between the internal electrode 122C and the internal electrode 122Eb.

In the present modification, the portion P2 includes the internal electrode 122A, the internal electrode 122Ea, and the piezoelectric layer between the internal electrode 122A and the internal electrode 122Ea. In the portion P2, the active region includes the piezoelectric layer between the internal electrode 122A and the internal electrode 122Ea.

In the present modification, as illustrated in FIG. 11, the external electrode 13 includes a plurality of external electrodes 132A, 132B, 132D, and 132E. Each of the plurality of external electrodes 132A, 132B, 132D, and 132E has the rectangular shape, when viewed from the second direction D2. In the present modification, a longitudinal direction of each of the external electrodes 132A, 132B, 132D, and 132E includes the first direction D1, and a lateral direction of each of the external electrodes 132A, 132B, 132D, and 132E includes the third direction D3. The longitudinal direction of each of the external electrodes 132A, 132B, 132D, and 132E may include the third direction D3. The lateral direction of each of the external electrodes 132A, 132B, 132D, and 132E may include the first direction D1.

The external electrodes 132A and 132B are disposed on the side surface 11c. For example, the external electrodes 132A and 132B are arranged in this order in the direction from the end surface 11e toward the end surface 11f in the third direction D3. The external electrodes 132D and 132E are disposed on the side surface 11d. For example, the external electrodes 132D and 132E are arranged in this order in the direction from the end surface 11e toward the end surface 11f in the third direction D3.

In the present modification, the external electrode 132A is connected to the connection conductors 162c disposed on the piezoelectric layer 14b, the piezoelectric layer 14d, and the piezoelectric layer 14f. As a result, the external electrode 132A is electrically connected to the internal electrodes 122C disposed on the piezoelectric layer 14b, the piezoelectric layer 14d, and the piezoelectric layer 14f.

The external electrode 132B is connected to the connection conductors 162e2 disposed on the piezoelectric layer 14c and the piezoelectric layer 14e. As a result, the external electrode 132B is electrically connected to the internal electrodes 122E disposed on the piezoelectric layer 14c and the piezoelectric layer 14e.

The external electrode 132D is connected to the connection conductors 162a disposed on the piezoelectric layer 14b, the piezoelectric layer 14d, and the piezoelectric layer 14f. As a result, the external electrode 132D is electrically connected to the internal electrodes 122A disposed on the piezoelectric layer 14b, the piezoelectric layer 14d, and the piezoelectric layer 14f.

The external electrode 132E is connected to the connection conductors 162e1 disposed on the piezoelectric layer 14c and the piezoelectric layer 14e. As a result, the external electrode 132E is electrically connected to the internal electrodes 122E disposed on the piezoelectric layer 14c and the piezoelectric layer 14e.

In the present modification, the amplifier 20 is electrically connected to the external electrode 132D. The oscillator 30 is electrically connected to the external electrode 132A. In the present modification, the oscillator 30 is also electrically connected to the external electrode 132B. As a result, the oscillator 30 applies the voltage to the portion P1. In the present modification, the oscillator 30 applies the voltage to the internal electrode 122C and the internal electrode 122E.

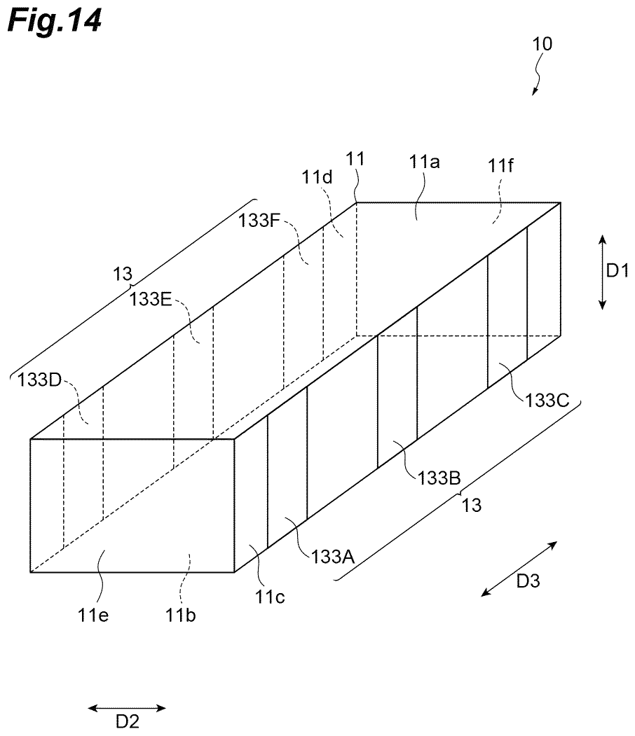

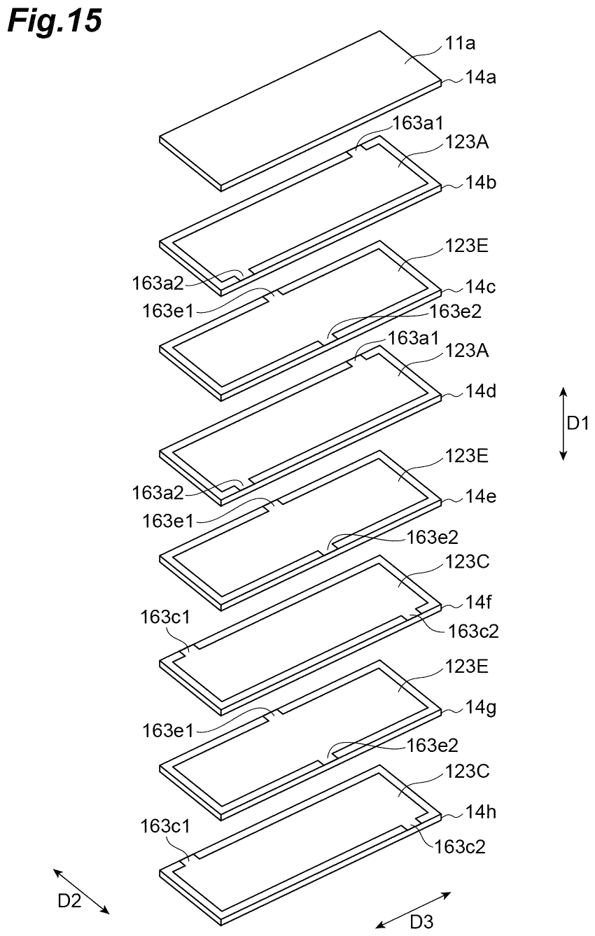

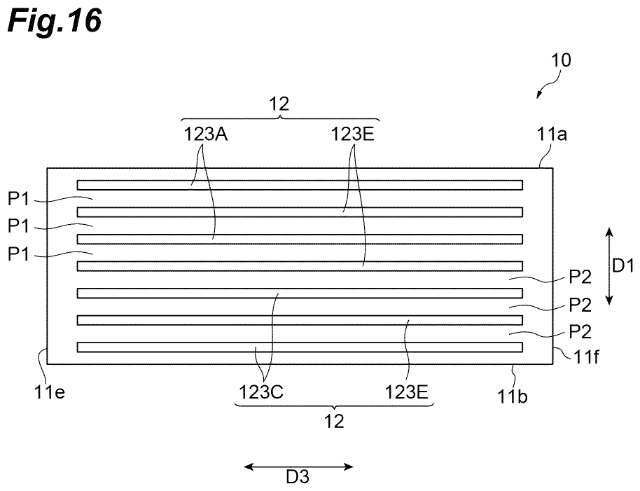

Next, a configuration of a third modification of the input device ID according to the present embodiment will be described with reference to FIGS. 14, 15, and 16. FIG. 14 is a perspective diagram of a piezoelectric element. FIG. 15 is an exploded perspective diagram of the piezoelectric element. FIG. 16 is a diagram illustrating a cross-sectional configuration of the piezoelectric element. In FIG. 16, hatching is omitted to clearly illustrate each part. In the present modification, configurations of the piezoelectric body 11, the internal electrode 12, and the external electrode 13 are different from those of the above-described embodiment. Hereinafter, differences between the above-described embodiment and the present modification will be mainly described.

As illustrated in FIG. 15, in the present modification, the piezoelectric body 11 includes piezoelectric layers 14g and 14h in addition to the piezoelectric layers 14a to 14f. In the present modification, the piezoelectric layers 14a to 14h are arranged in this order in the first direction D1. The piezoelectric body 11 also includes one or more piezoelectric layers located between the plurality of piezoelectric layers 14a to 14h. The piezoelectric layers 14g and 14h have a rectangular shape, when viewed from the first direction D1, similarly to the piezoelectric layers 14a to 14f. The piezoelectric layers 14g and 14h include the piezoelectric ceramic material.

As illustrated in FIG. 15, in the present modification, the internal electrode 12 includes a plurality of internal electrodes 123A, a plurality of internal electrodes 123C, and a plurality of internal electrodes 123E. Each of the internal electrodes 123A, 123C, and 123E has the rectangular shape. That is, in the present modification, the piezoelectric element 10 includes the plurality of internal electrodes 123A, 123C, and 123E.

The internal electrode 123A is disposed on the piezoelectric layer 14b and the piezoelectric layer 14d. The internal electrode 123A has, for example, the rectangular shape. In the present embodiment, the internal electrode 123A has a rectangular shape slightly smaller than the piezoelectric body 11, when viewed from the first direction D1.

The internal electrode 123C is disposed on the piezoelectric layer 14f and the piezoelectric layer 14h. The internal electrode 123C has, for example, the rectangular shape. In the present embodiment, the internal electrode 123C has a rectangular shape slightly smaller than the piezoelectric body 11, when viewed from the first direction D1.

The internal electrode 123E is disposed on the piezoelectric layer 14c, the piezoelectric layer 14e, and the piezoelectric layer 14g. The internal electrode 123E has, for example, a rectangular shape. In the present embodiment, the internal electrode 123E has a rectangular shape slightly smaller than the piezoelectric body 11, when viewed from the first direction D1.

In the present modification, the piezoelectric body 11 includes connection conductors 163a1, 163a2, 163c1, 163c2, 163e1, and 163e2. The connection conductors 163a1, 163c1, and 163e1 are exposed to the side surface 11d. The connection conductors 163a2, 163c2, and 163e2 are exposed to the side surface 11c.

The connection conductors 163a1 and 163a2 are disposed on the piezoelectric layer 14b and the piezoelectric layer 14d. The connection conductor 163a1 and the connection conductor 163a2 are exposed to corresponding side surfaces of the pair of side surfaces 11c and 11d at different positions in the third direction D3, for example.

The connection conductors 163c1 and 163c2 are disposed on the piezoelectric layer 14f and the piezoelectric layer 14h. The connection conductor 163c1 and the connection conductor 163c2 are exposed to corresponding side surfaces of the pair of side surfaces 11c and 11d at different positions in the third direction D3, for example.

The connection conductors 163e1 and 163e2 are disposed on the piezoelectric layer 14c, the piezoelectric layer 14e, and the piezoelectric layer 14g. The connection conductor 163e1 and the connection conductor 163e2 are exposed to corresponding side surfaces of the pair of side surfaces 11c and 11d at the same position in the third direction D3, for example.

In the piezoelectric layers 14b and 14d, the connection conductors 163a1 and 163a2 are connected to the internal electrode 123A. For example, the connection conductor 163a1 is connected to an edge of the internal electrode 123A closer to the side surface 11d, at a position closer to the end surface 11f in the third direction D3 of the internal electrode 123A. For example, the connection conductor 163a2 is connected to an edge of the internal electrode 123A closer to the side surface 11c, at a position closer to the end surface 11e in the third direction D3 of the internal electrode 123A. The connection conductors 163a1 and 163a2 and the internal electrode 123A are physically and electrically connected, for example.

In the piezoelectric layers 14f and 14h, the connection conductors 163c1 and 163c2 are connected to the internal electrode 123C. For example, the connection conductor 163c1 is connected to an edge of the internal electrode 123C closer to the side surface 11d, at a position closer to the end surface 11e in the third direction D3 of the internal electrode 123C. For example, the connection conductor 163c2 is connected to an edge of the internal electrode 123C closer to the side surface 11c, at a position closer to the end surface 11f in the third direction D3 of the internal electrode 123C. The connection conductors 163c1 and 163c2 and the internal electrode 123C are physically and electrically connected, for example.

In the piezoelectric layers 14c, 14e, and 14g, the connection conductors 163e1 and 163e2 are connected to the internal electrode 123E. For example, the connection conductor 163e1 is connected to an edge of the internal electrode 123E closer to the side surface 11d, at substantially the center of the internal electrode 123E in the third direction D3. For example, the connection conductor 163e2 is connected to an edge of the internal electrode 123E closer to the side surface 11c, at substantially the center of the internal electrode 123E in the third direction D3. The connection conductors 163e1 and 163e2 and the internal electrode 123E are physically and electrically connected, for example.

As illustrated in FIG. 16, the internal electrode 123A disposed on the piezoelectric layer 14b opposes the internal electrode 123E disposed on the piezoelectric layer 14c with the piezoelectric layer. The internal electrode 123E disposed on the piezoelectric layer 14c opposes the internal electrode 123A disposed on the piezoelectric layer 14d with the piezoelectric layer. The internal electrode 123A disposed on the piezoelectric layer 14d opposes the internal electrode 123E disposed on the piezoelectric layer 14e with the piezoelectric layer.

The internal electrode 123E disposed on the piezoelectric layer 14e opposes the internal electrode 123C disposed on the piezoelectric layer 14f with the piezoelectric layer. The internal electrode 123C disposed on the piezoelectric layer 14f opposes the internal electrode 123E disposed on the piezoelectric layer 14g with the piezoelectric layer. The internal electrode 123E disposed on the piezoelectric layer 14g opposes the internal electrode 123C disposed on the piezoelectric layer 14h with the piezoelectric layer.

In the present modification, the portion P1 includes the internal electrode 123A, the internal electrode 123E, and the piezoelectric layer between the internal electrode 123A and the internal electrode 123E. In the portion P1, the active region includes the piezoelectric layer between the internal electrode 123A and the internal electrode 123E.

In the present modification, the portion P2 includes the internal electrode 123C, the internal electrode 123E, and the piezoelectric layer between the internal electrode 123C and the internal electrode 123E. In the portion P2, the active region includes the piezoelectric layer between the internal electrode 123C and the internal electrode 123E.

In the present modification, as illustrated in FIG. 14, the external electrode 13 includes a plurality of external electrodes 133A, 133B, 133C, 133D, 133E, and 133F. Each of the plurality of external electrodes 133A, 133B, 133C, 133D, 133E, and 133F has the rectangular shape, when viewed from the second direction D2. In the present modification, a longitudinal direction of each of the external electrodes 133A, 133B, 133C, 133D, 133E, and 133F includes the first direction D1, and a lateral direction of each of the external electrodes 133A, 133B, 133C, 133D, 133E, and 133F includes the third direction D3. The longitudinal direction of each of the external electrodes 133A, 133B, 133C, 133D, 133E, and 133F may include the third direction D3. The lateral direction of each of the external electrodes 133A, 133B, 133C, 133D, 133E, and 133F may include the first direction D1.

The external electrodes 133A, 133B, and 133C are disposed on the side surface 11c. For example, the external electrodes 133A, 133B, and 133C are arranged in this order in the direction from the end surface 11e toward the end surface 11f in the third direction D3. The external electrodes 133D, 133E, and 133F are disposed on the side surface 11d. For example, the external electrodes 133D, 133E, and 133F are arranged in this order in the direction from the end surface 11e toward the end surface 11f in the third direction D3.

In the present modification, the external electrode 133A is connected to the connection conductors 163a2 disposed on the piezoelectric layer 14b and the piezoelectric layer 14d. As a result, the external electrode 133A is electrically connected to the internal electrodes 123A disposed on the piezoelectric layer 14b and the piezoelectric layer 14d.

The external electrode 133B is connected to the connection conductors 163e2 disposed on the piezoelectric layer 14c, the piezoelectric layer 14e, and the piezoelectric layer 14g. As a result, the external electrode 133B is electrically connected to the internal electrodes 123E disposed on the piezoelectric layer 14c, the piezoelectric layer 14e, and the piezoelectric layer 14g.

The external electrode 133C is connected to the connection conductors 163c2 disposed on the piezoelectric layer 14f and the piezoelectric layer 14h. As a result, the external electrode 133C is electrically connected to the internal electrodes 123C disposed on the piezoelectric layer 14f and the piezoelectric layer 14h.

The external electrode 133D is connected to the connection conductors 163c1 disposed on the piezoelectric layer 14f and the piezoelectric layer 14h. As a result, the external electrode 133D is electrically connected to the internal electrodes 123C disposed on the piezoelectric layer 14f and the piezoelectric layer 14h.

The external electrode 133E is connected to the connection conductors 163e1 disposed on the piezoelectric layer 14c, the piezoelectric layer 14e, and the piezoelectric layer 14g. As a result, the external electrode 133E is electrically connected to the internal electrodes 123E disposed on the piezoelectric layer 14c, the piezoelectric layer 14e, and the piezoelectric layer 14g.

The external electrode 133F is connected to the connection conductors 163a1 disposed on the piezoelectric layer 14b and the piezoelectric layer 14d. As a result, the external electrode 133F is electrically connected to the internal electrodes 123A disposed on the piezoelectric layer 14b and the piezoelectric layer 14d.

In the present modification, the amplifier 20 is electrically connected to the external electrode 133C. The oscillator 30 is electrically connected to the external electrode 133A. In the present modification, the oscillator 30 is also electrically connected to the external electrode 133B. As a result, the oscillator 30 applies the voltage to the portion P1. In the present modification, the oscillator 30 applies the voltage to the internal electrode 123A and the internal electrode 123E.

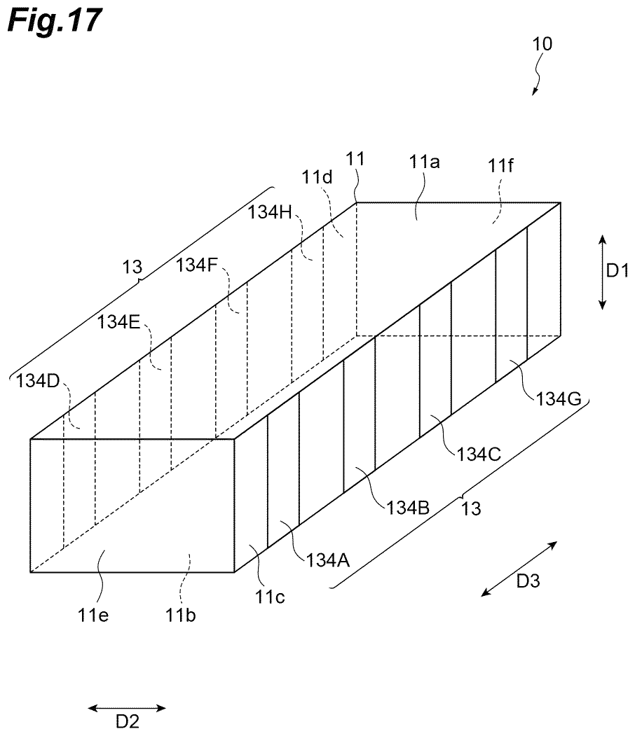

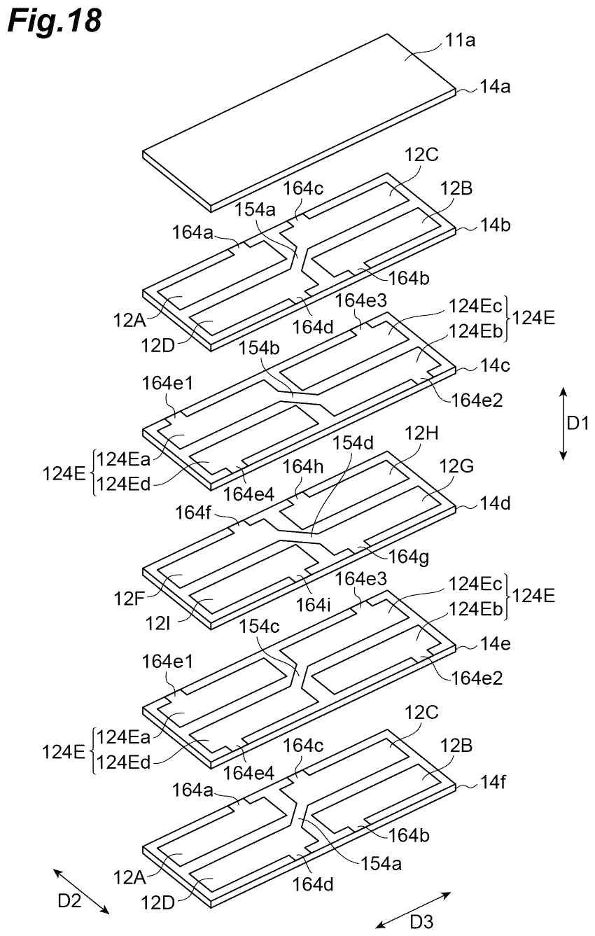

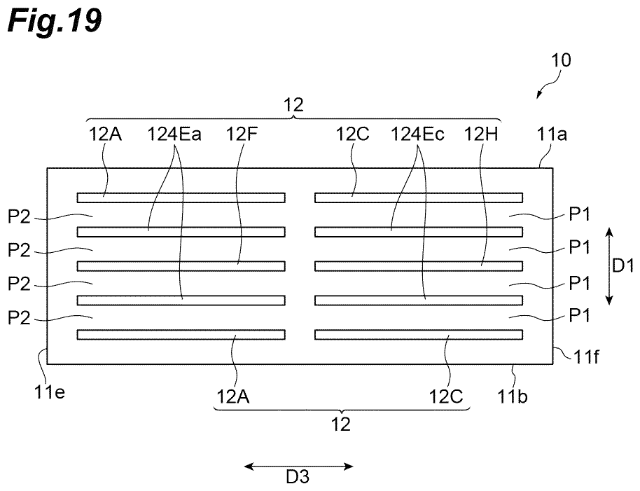

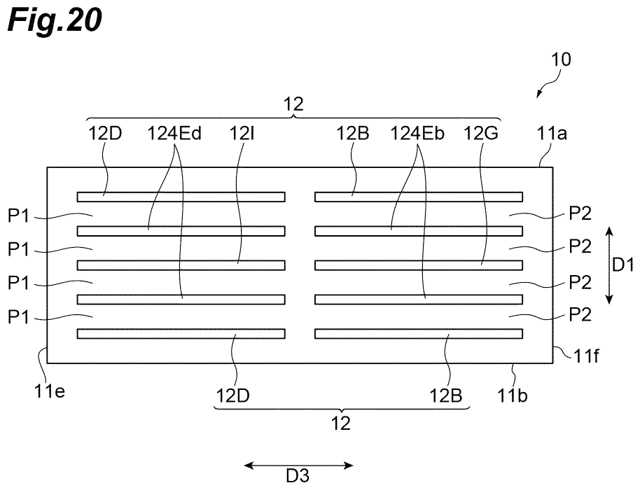

Next, a configuration of a fourth modification of the input device ID according to the present embodiment will be described with reference to FIGS. 17, 18, 19, and 20. FIG. 17 is a perspective diagram of a piezoelectric element. FIG. 18 is an exploded perspective diagram of the piezoelectric element. FIG. 19 is a diagram illustrating a cross-sectional configuration of the piezoelectric element. FIG. 20 is a diagram illustrating a cross-sectional configuration of the piezoelectric element. In FIGS. 19 and 20, hatching is omitted to clearly illustrate each part. In the present modification, the configurations of the internal electrode 12 and the external electrode 13 are different from those of the above-described embodiment. Hereinafter, differences between the above-described embodiment and the present modification will be mainly described.

As illustrated in FIG. 18, in the present modification, the internal electrode 12 includes the pair of internal electrodes 12A and 12B, the pair of internal electrodes 12C and 12D, a plurality of internal electrodes 124E, the pair of internal electrodes 12F and 12G, and the pair of internal electrodes 12H and 12I.

In the present modification, in the piezoelectric layer 14b and the piezoelectric layer 14f, the internal electrode 12C and the internal electrode 12D are physically and electrically connected by a connection portion 154a.

The internal electrode 124E is disposed on the piezoelectric layer 14c and the piezoelectric layer 14e. In the present modification, the internal electrode 124E includes a pair of internal electrodes 124Ea and 124Eb and a pair of internal electrodes 124Ec and 124Ed.

The internal electrodes 124Ea and 124Eb are disposed at the one diagonal of the rectangular shape of the piezoelectric body 11. In the present modification, the internal electrode 124Ea is disposed at the corner formed by the side surface 11d and the end surface 11e, and the internal electrode 124Eb is disposed at the corner formed by the side surface 11c and the end surface 11f.

The internal electrodes 124Ec and 124Ed are disposed at the other diagonal of the rectangular shape of the piezoelectric body 11. In the present modification, the internal electrode 124Ec is disposed at the corner portion formed by the side surface 11d and the end surface 11f, and the internal electrode 124Ed is disposed at the corner portion formed by the side surface 11c and the end surface 11e.

In the piezoelectric layers 14c and 14e, the internal electrode 124Ea and the internal electrode 124Ec are adjacent to the side surface 11d, and the internal electrode 124Eb and the internal electrode 124Ed are adjacent to the side surface 11c. In the present modification, in the piezoelectric layer 14c, the internal electrode 124Ea and the internal electrode 124Eb are physically and electrically connected by a connection portion 154b. The connection portion 154b extends, for example, in the diagonal direction of the one diagonal. In the present modification, in the piezoelectric layer 14e, the internal electrode 124Ec and the internal electrode 124Ed are physically and electrically connected by a connection portion 154c. The connection portion 154c extends, for example, in the diagonal direction of the other diagonal.

In the present modification, in the piezoelectric layer 14d, the internal electrode 12F and the internal electrode 12G are physically and electrically connected by a connection portion 154d. The connection portion 154d extends, for example, in the diagonal direction of the one diagonal. In the present modification, in the piezoelectric layer 14f, the internal electrode 12C and the internal electrode 12D are physically and electrically connected by a connection portion 154e. The connection portion 154e extends, for example, in the diagonal direction of the other diagonal.

In the present embodiment, the piezoelectric body 11 includes connection conductors 164a, 164b, 164c, 164d, 164e1, 164e2, 164e3, 164e4, 164f, 164g, 164h, and 164i. The connection conductors 164a, 164c, 164e1, 164e3, 164f, and 164h are exposed to the side surface 11d. The connection conductors 164b, 164d, 164e2, 164e4, 164g, and 164i are exposed to the side surface 11c.

The connection conductors 164a, 164b, 164c, and 164d are disposed on the piezoelectric layer 14b and the piezoelectric layer 14f. In the piezoelectric layer 14b and the piezoelectric layer 14f, the connection conductor 164a and the connection conductor 164c are exposed to the side surface 11d at different positions in the third direction D3, for example. The connection conductor 164b and the connection conductor 164d are exposed to the side surface 11c at different positions in the third direction D3, for example. The connection conductor 164a and the connection conductor 164d are exposed to corresponding side surfaces of the pair of side surfaces 11c and 11d at the same position in the third direction D3, for example. The connection conductor 164b and the connection conductor 164c are exposed to corresponding side surfaces of the pair of side surfaces 11c and 11d at the same position in the third direction D3, for example.

In the present modification, for example, the connection conductor 164a is connected to the edge of the internal electrode 12A closer to the side surface 11d, at a position closer to the end surface 11f in the third direction D3 of the internal electrode 12A. For example, the connection conductor 164b is connected to the edge of the internal electrode 12B closer to the side surface 11c, at a position closer to the end surface 11e in the third direction D3 of the internal electrode 12B. For example, the connection conductor 164c is connected to the edge of the internal electrode 12C closer to the side surface 11d, at a position closer to the end surface 11e in the third direction D3 of the internal electrode 12C. For example, the connection conductor 164d is connected to the edge of the internal electrode 12D closer to the side surface 11c, at a position closer to the end surface 11f in the third direction D3 of the internal electrode 12D.

The connection conductors 164e1, 164e2, 164e3, and 164e4 are disposed on the piezoelectric layer 14c and the piezoelectric layer 14e. In the piezoelectric layer 14c and the piezoelectric layer 14e, the connection conductor 164e1 and the connection conductor 164e3 are exposed to the side surface 11d at different positions in the third direction D3, for example. The connection conductor 164e2 and the connection conductor 164e4 are exposed to the side surface 11c at different positions in the third direction D3, for example. The connection conductor 164e1 and the connection conductor 164e4 are exposed to corresponding side surfaces of the pair of side surfaces 11c and 11d at the same position in the third direction D3, for example. The connection conductor 164e2 and the connection conductor 164e3 are exposed to corresponding side surfaces of the pair of side surfaces 11c and 11d at the same position in the third direction D3, for example.

In the piezoelectric layer 14c and the piezoelectric layer 14e, the connection conductor 164e1 is connected to the internal electrode 124Ea. For example, the connection conductor 164e1 is connected to an edge of the internal electrode 124Ea closer to the side surface 11d, at a position closer to the end surface 11e in the third direction D3 of the internal electrode 124Ea. The connection conductor 164e1 and the internal electrode 124Ea are physically and electrically connected, for example.

In the piezoelectric layer 14c and the piezoelectric layer 14e, the connection conductor 164e2 is connected to the internal electrode 124Eb. For example, the connection conductor 164e2 is connected to an edge of the internal electrode 124Eb closer to the side surface 11c, at a position closer to the end surface 11f in the third direction D3 of the internal electrode 124Eb. The connection conductor 164e2 and the internal electrode 124Eb are physically and electrically connected, for example.

In the piezoelectric layer 14c and the piezoelectric layer 14e, the connection conductor 164e3 is connected to the internal electrode 124Ec. For example, the connection conductor 164e3 is connected to an edge of the internal electrode 124Ec closer to the side surface 11d, at a position closer to the end surface 11f in the third direction D3 of the internal electrode 124Ec. The connection conductor 164e3 and the internal electrode 124Ec are physically and electrically connected, for example.

In the piezoelectric layer 14c and the piezoelectric layer 14e, the connection conductor 164e4 is connected to the internal electrode 124Ed. For example, the connection conductor 164e4 is connected to an edge of the internal electrode 124Ed closer to the side surface 11c, at a position closer to the end surface 11e in the third direction D3 of the internal electrode 124Ed. The connection conductor 164e4 and the internal electrode 124Ed are physically and electrically connected, for example.

The connection conductors 164f, 164g, 164h, and 164i are disposed on the piezoelectric layer 14d. In the piezoelectric layer 14d, the connection conductor 164f and the connection conductor 164h are exposed to the side surface 11d at different positions in the third direction D3, for example. The connection conductor 164g and the connection conductor 164i are exposed to the side surface 11c at different positions in the third direction D3, for example. The connection conductor 164f and the connection conductor 164i are exposed to corresponding side surfaces of the pair of side surfaces 11c and 11d at the same position in the third direction D3, for example. The connection conductor 164h and the connection conductor 164g are exposed to corresponding side surfaces of the pair of side surfaces 11c and 11d at the same position in the third direction D3, for example.

In the present modification, for example, the connection conductor 164f is connected to the edge of the internal electrode 12F closer to the side surface 11d, at a position closer to the end surface 11f in the third direction D3 of the internal electrode 12F. For example, the connection conductor 164g is connected to the edge of the internal electrode 12G closer to the side surface 11c, at a position closer to the end surface 11e in the third direction D3 of the internal electrode 12G. For example, the connection conductor 164h is connected to the edge of the internal electrode 12H closer to the side surface 11d, at a position closer to the end surface 11e in the third direction D3 of the internal electrode 12H. For example, the connection conductor 164i is connected to the edge of the internal electrode 12I closer to the side surface 11c, at a position closer to the end surface 11f in the third direction D3 of the internal electrode 12I.

As illustrated in FIGS. 19 and 20, the internal electrodes 12A, 12B, 12C, and 12D disposed on the piezoelectric layer 14b oppose the internal electrode 124E disposed on the piezoelectric layer 14c with the part of the piezoelectric body 11. In the present modification, the internal electrode 12A disposed on the piezoelectric layer 14b opposes the internal electrode 124Ea disposed on the piezoelectric layer 14c with the piezoelectric layer. The internal electrode 12B disposed on the piezoelectric layer 14b opposes the internal electrode 124Eb disposed on the piezoelectric layer 14c with the piezoelectric layer. The internal electrode 12C disposed on the piezoelectric layer 14b opposes the internal electrode 124Ec disposed on the piezoelectric layer 14c with the piezoelectric layer. The internal electrode 12D disposed on the piezoelectric layer 14b opposes the internal electrode 124Ed disposed on the piezoelectric layer 14c with the piezoelectric layer.

The internal electrode 124E disposed on the piezoelectric layer 14c opposes the internal electrodes 12F, 12G, 12H, and 12I disposed on the piezoelectric layer 14d with the part of the piezoelectric body 11. In the present modification, the internal electrode 124Ea disposed on the piezoelectric layer 14c opposes the internal electrode 12F disposed on the piezoelectric layer 14d with the piezoelectric layer. The internal electrode 124Eb disposed on the piezoelectric layer 14c opposes the internal electrode 12G disposed on the piezoelectric layer 14d with the piezoelectric layer. The internal electrode 124Ec disposed on the piezoelectric layer 14c opposes the internal electrode 12H disposed on the piezoelectric layer 14d with the piezoelectric layer. The internal electrode 124Ed disposed on the piezoelectric layer 14c opposes the internal electrode 12I disposed on the piezoelectric layer 14d with the piezoelectric layer.

The internal electrodes 12F, 12G, 12H, and 12I disposed on the piezoelectric layer 14d oppose the internal electrode 124E disposed on the piezoelectric layer 14e with the part of the piezoelectric body 11. In the present modification, the internal electrode 12F disposed on the piezoelectric layer 14d opposes the internal electrode 124Ea disposed on the piezoelectric layer 14e with the piezoelectric layer. The internal electrode 12G disposed on the piezoelectric layer 14d opposes the internal electrode 124Eb disposed on the piezoelectric layer 14e with the piezoelectric layer. The internal electrode 12H disposed on the piezoelectric layer 14d opposes the internal electrode 124Ec disposed on the piezoelectric layer 14e with the piezoelectric layer. The internal electrode 12I disposed on the piezoelectric layer 14d opposes the internal electrode 124Ed disposed on the piezoelectric layer 14e with the piezoelectric layer.

The internal electrode 124E disposed on the piezoelectric layer 14e opposes the internal electrodes 12A, 12B, 12C, and 12D disposed on the piezoelectric layer 14f with the part of the piezoelectric body 11. In the present modification, the internal electrode 124Ea disposed on the piezoelectric layer 14e opposes the internal electrode 12A disposed on the piezoelectric layer 14f with the piezoelectric layer. The internal electrode 124Eb disposed on the piezoelectric layer 14e opposes the internal electrode 12B disposed on the piezoelectric layer 14f with the piezoelectric layer. The internal electrode 124Ec disposed on the piezoelectric layer 14e opposes the internal electrode 12C disposed on the piezoelectric layer 14f with the piezoelectric layer. The internal electrode 124Ed disposed on the piezoelectric layer 14e opposes the internal electrode 12D disposed on the piezoelectric layer 14f with the piezoelectric layer.

In the present modification, the portion P1 includes the internal electrode 12C, the internal electrode 124Ec, and the piezoelectric layer between the internal electrode 12C and the internal electrode 124Ec. In the portion P1, the active region includes the piezoelectric layer between the internal electrode 12C and the internal electrode 124Ec.

The portion P1 includes the internal electrode 12D, the internal electrode 124Ed, and the piezoelectric layer between the internal electrode 12D and the internal electrode 124Ed. In the portion P1, the active region includes the piezoelectric layer between the internal electrode 12D and the internal electrode 124Ed.

The portion P1 includes the internal electrode 12H, the internal electrode 124Ec, and the piezoelectric layer between the internal electrode 12H and the internal electrode 124Ec. In the portion P1, the active region includes the piezoelectric layer between the internal electrode 12H and the internal electrode 124Ec.

The portion P1 includes the internal electrode 12I, the internal electrode 124Ed, and the piezoelectric layer between the internal electrode 12I and the internal electrode 124Ed. In the portion P1, the active region includes the piezoelectric layer between the internal electrode 12I and the internal electrode 124Ed.

In the present modification, the portion P2 includes the internal electrode 12A, the internal electrode 124Ea, and the piezoelectric layer between the internal electrode 12A and the internal electrode 124Ea. In the portion P2, the active region includes the piezoelectric layer between the internal electrode 12A and the internal electrode 124Ea.

The portion P2 includes the internal electrode 12B, the internal electrode 124Eb, and the piezoelectric layer between the internal electrode 12B and the internal electrode 124Eb. In the portion P2, the active region includes the piezoelectric layer between the internal electrode 12B and the portion of the internal electrode 124Eb.

The portion P2 includes the internal electrode 12F, the internal electrode 124Ea, and the piezoelectric layer between the internal electrode 12F and the internal electrode 124Ea. In the portion P2, the active region includes the piezoelectric layer between the internal electrode 12F and the internal electrode 124Ea.

The portion P2 includes the internal electrode 12G, the internal electrode 124Eb, and the piezoelectric layer between the internal electrode 12G and the internal electrode 124Eb. In the portion P2, the active region includes the piezoelectric layer between the internal electrode 12G and the portion of the internal electrode 124Eb.

In the present modification, as illustrated in FIG. 17, the external electrode 13 includes a plurality of external electrodes 134A, 134B, 134C, 134D, 134E, 134F, 134G, and 134H. Each of the plurality of external electrodes 134A, 134B, 134C, 134D, 134E, 134F, 134G, and 134H has the rectangular shape, when viewed from the second direction D2. In the present modification, a longitudinal direction of each of the external electrodes 134A, 134B, 134C, 134D, 134E, 134F, 134G, and 134H includes the first direction D1. A lateral direction of each of the external electrodes 134A, 134B, 134C, 134D, 134E, 134F, 134G, and 134H includes the third direction D3. The longitudinal direction of each of the external electrodes 134A, 134B, 134C, 134D, 134E, 134F, 134G, and 134H may include the third direction D3. The lateral direction of each of the external electrodes 134A, 134B, 134C, 134D, 134E, 134F, 134G, and 134H may include the first direction D1.

The external electrodes 134A, 134B, 134C, and 134G are disposed on the side surface 11c. For example, the external electrodes 134A, 134B, 134C, and 134G are arranged in this order in the direction from the end surface 11e toward the end surface 11f in the third direction D3. The external electrodes 134D, 134E, 134F, and 134H are disposed on the side surface 11d. For example, the external electrodes 134D, 134E, 134F, and 134H are arranged in this order in the direction from the end surface 11e toward the end surface 11f in the third direction D3.

In the present modification, the external electrode 134A is connected to the connection conductors 164e4 disposed on the piezoelectric layer 14c and the piezoelectric layer 14e. As a result, the external electrode 134A is electrically connected to the internal electrodes 124Ed disposed on the piezoelectric layer 14c and the piezoelectric layer 14e.

The external electrode 134B is connected to the connection conductors 164d disposed on the piezoelectric layer 14b and the piezoelectric layer 14f, and the connection conductor 164i disposed on the piezoelectric layer 14d. As a result, the external electrode 134B is electrically connected to the internal electrodes 12D disposed on the piezoelectric layer 14b and the piezoelectric layer 14f, and the internal electrode 12I disposed on the piezoelectric layer 14d.

The external electrode 134C is connected to the connection conductors 164b disposed on the piezoelectric layer 14b and the piezoelectric layer 14f, and the connection conductor 164g disposed on the piezoelectric layer 14d. As a result, the external electrode 134C is electrically connected to the internal electrodes 12B disposed on the piezoelectric layer 14b and the piezoelectric layer 14f, and the internal electrode 12G disposed on the piezoelectric layer 14d.

In the present modification, the external electrode 134G is connected to the connection conductors 164e2 disposed on the piezoelectric layer 14c and the piezoelectric layer 14e. As a result, the external electrode 134G is electrically connected to the internal electrodes 124Eb disposed on the piezoelectric layer 14c and the piezoelectric layer 14e.

The external electrode 134D is connected to the connection conductors 164e1 disposed on the piezoelectric layer 14c and the piezoelectric layer 14e. As a result, the external electrode 134D is electrically connected to the internal electrodes 124Ea disposed on the piezoelectric layer 14c and the piezoelectric layer 14e.

The external electrode 134E is connected to the connection conductors 164a disposed on the piezoelectric layer 14b and the piezoelectric layer 14f, and the connection conductor 164f disposed on the piezoelectric layer 14d. As a result, the external electrode 134E is electrically connected to the internal electrodes 12A disposed on the piezoelectric layer 14b and the piezoelectric layer 14f, and the internal electrode 12F disposed on the piezoelectric layer 14d.

The external electrode 134F is connected to the connection conductors 164c disposed on the piezoelectric layer 14b and the piezoelectric layer 14f, and the connection conductor 164h disposed on the piezoelectric layer 14d. As a result, the external electrode 134F is electrically connected to the internal electrodes 12C disposed on the piezoelectric layer 14b and the piezoelectric layer 14f, and the internal electrode 12H disposed on the piezoelectric layer 14d.

In the present modification, the external electrode 134H is connected to the connection conductors 164e3 disposed on the piezoelectric layer 14c and the piezoelectric layer 14e. As a result, the external electrode 134H is electrically connected to the internal electrodes 124Ec disposed on the piezoelectric layer 14c and the piezoelectric layer 14e.

In the present modification, the amplifier 20 is electrically connected to the external electrode 134C. The oscillator 30 is electrically connected to the external electrode 134B. In the present modification, the oscillator 30 is also electrically connected to the external electrodes 134A and 134G. As a result, the oscillator 30 applies a voltage to the portion P1. In the present modification, the oscillator 30 applies the voltage to the internal electrode 12C and the internal electrode 124E, the internal electrode 12D and the internal electrode 124E, the internal electrode 12H and the internal electrode 124E, and the internal electrode 12I and the internal electrode 124E.

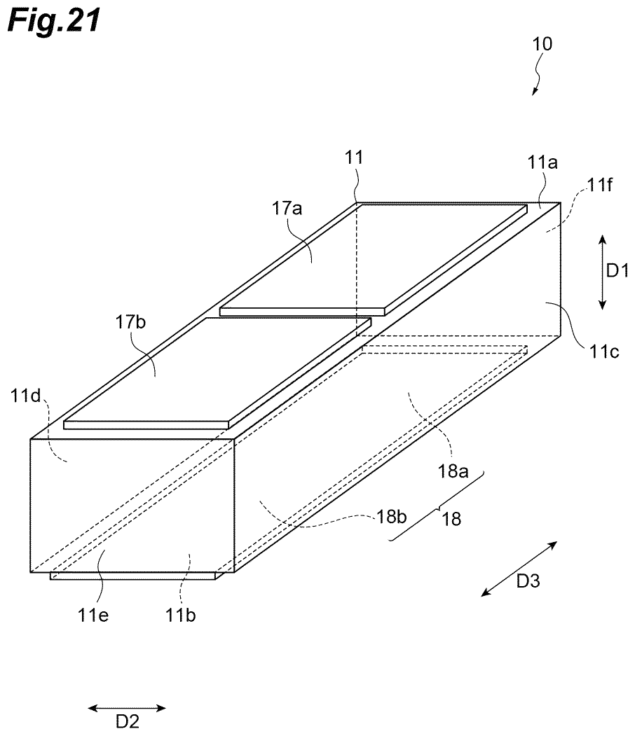

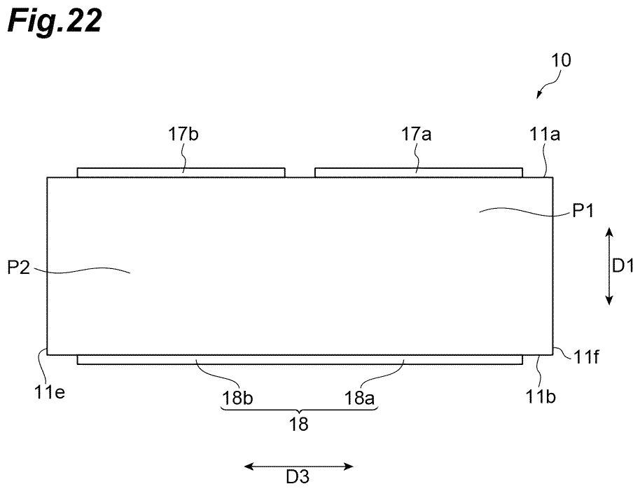

Next, a configuration of a fifth modification of the input device ID according to the present embodiment will be described with reference to FIGS. 21 and 22. FIG. 21 is a perspective diagram of a piezoelectric element. FIG. 22 is a diagram illustrating a cross-sectional configuration of the piezoelectric element. In FIG. 22, hatching is omitted to clearly illustrate each part. In the present modification, the configuration of the piezoelectric element 10 is different from that of the above-described embodiment. Hereinafter, differences between the above-described embodiment and the present modification will be mainly described.

In the present modification, the piezoelectric element 10 includes electrodes 17a and 17b and an electrode 18 instead of the internal electrode 12 and the external electrode 13. The electrodes 17a and 17b and the electrode 18 have the rectangular shape.

The electrodes 17a and 17b and the electrode 18 are disposed on the piezoelectric body 11. As illustrated in FIG. 21, in the present modification, the electrodes 17a and 17b are disposed on the principal surface 11a of the piezoelectric body 11. The electrode 17a is disposed closer to the end surface 11f than the center of the principal surface 11a in the third direction D3, when viewed from the first direction D1. The electrode 17b is disposed closer to the end surface 11e than the center of the principal surface 11a in the third direction D3, when viewed from the first direction D1.

The electrode 18 is disposed on the principal surface 11b of the piezoelectric body 11. The electrode 18 has a rectangular shape slightly smaller than the rectangular shape of the piezoelectric body 11, when viewed from the first direction D1. In the present modification, the electrode 18 includes an electrode 18a and an electrode 18b. The electrode 18a is disposed closer to the end surface 11f than the center of the principal surface 11b in the third direction D3, when viewed from the first direction D1. The electrode 18b is disposed closer to the end surface 11e than the center of the principal surface 11b in the third direction D3, when viewed from the first direction D1. In the present modification, the electrode 18a and the electrode 18b are integrated.

As illustrated in FIG. 22, the electrode 17a and the electrode 17b disposed on the principal surface 11a oppose the electrode 18 disposed on the principal surface 11b with the part of the piezoelectric body 11. In the present modification, the electrode 17a disposed on the principal surface 11a opposes the electrode 18a disposed on the principal surface 11b with the piezoelectric layer. The electrode 17b disposed on the principal surface 11a opposes the electrode 18b disposed on the principal surface 11b with the piezoelectric layer.

In the present modification, the portion P1 includes the electrode 17a, the electrode 18a, and the piezoelectric layer between the electrode 17a and the electrode 18a. In the portion P1, the active region includes the piezoelectric layer between the electrode 17a and the electrode 18a.

In the present modification, the portion P2 includes the electrode 17b, the electrode 18b, and the piezoelectric layer between the electrode 17b and the electrode 18b. In the portion P2, the active region includes the piezoelectric layer between the electrode 17b and the electrode 18b.

In the present modification, the amplifier 20 is electrically connected to the electrode 17b. The oscillator 30 is electrically connected to the electrode 17a. In the present modification, the oscillator 30 is also electrically connected to the electrode 18. As a result, the oscillator 30 applies the voltage to the portion P1. In the present modification, the oscillator 30 applies the voltage to the electrode 17a and the electrode 18.

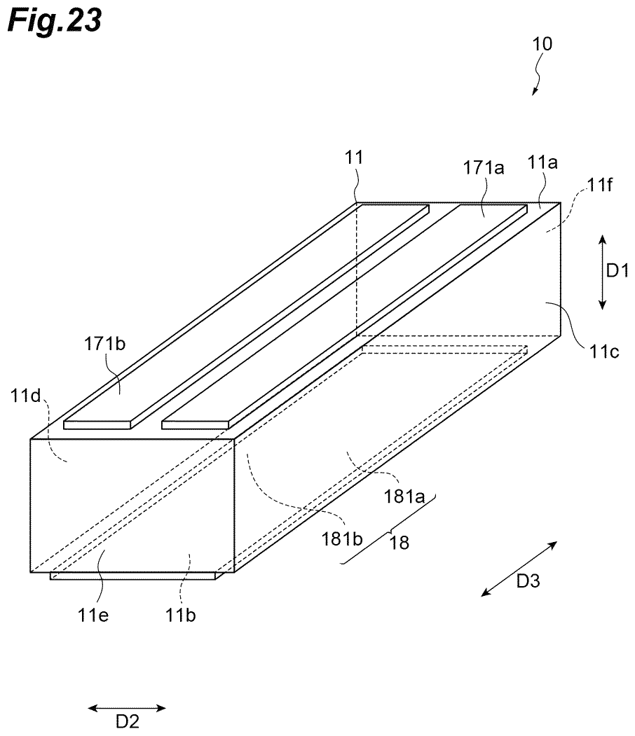

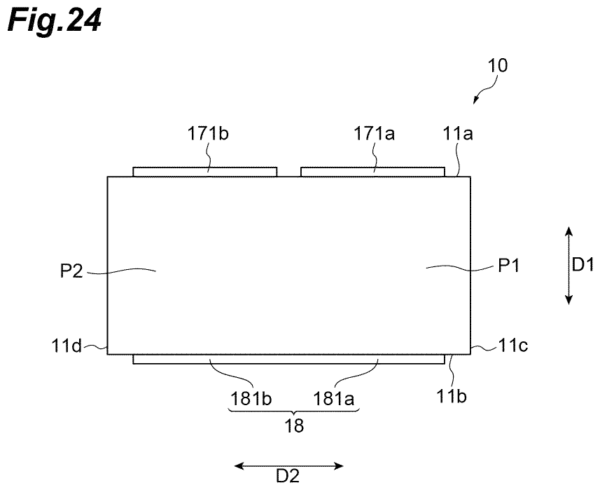

Next, a configuration of a sixth modification of the input device ID according to the present embodiment will be described with reference to FIGS. 23 and 24. FIG. 23 is a perspective diagram of a piezoelectric element. FIG. 24 is a diagram illustrating a cross-sectional configuration of the piezoelectric element. In FIG. 24, hatching is omitted to clearly illustrate each part. In the present modification, the configuration of the piezoelectric element 10 is different from that of the above-described fifth modification. Hereinafter, differences between the above-described fifth modification and the present modification will be mainly described.

In the present modification, the piezoelectric element 10 includes electrodes 171a and 171b instead of the electrodes 17a and 17b. The electrodes 171a and 171b have, for example, the rectangular shape.

As illustrated in FIG. 23, the electrodes 171a and 171b are disposed on the principal surface 11a. In the present modification, the electrode 171a is disposed closer to the side surface 11c than the center of the principal surface 11a in the second direction D2, when viewed from the first direction D1. The electrode 171b is disposed closer to the side surface 11d than the center of the principal surface 11a in the second direction D2, when viewed from the first direction D1.

In the present modification, the electrode 18 includes an electrode 181a and an electrode 181b. The electrode 181a is disposed closer to the side surface 11c than the center of the principal surface 11b in the second direction D2, when viewed from the first direction D1. The electrode 181b is disposed closer to the side surface 11d than the center of the principal surface 11b in the second direction D2, when viewed from the first direction D1. In the present modification, the electrode 181a and the electrode 181b are integrated.

As illustrated in FIG. 24, the electrode 171a and the electrode 171b disposed on the principal surface 11a oppose the electrode 18 disposed on the principal surface 11b via a part of the piezoelectric body 11. In the present modification, the electrode 171a disposed on the principal surface 11a opposes the electrode 181a disposed on the principal surface 11b with the piezoelectric layer. The electrode 171b disposed on the principal surface 11a opposes the electrode 181b disposed on the principal surface 11b with the piezoelectric layer.

In the present modification, the portion P1 includes the electrode 171a, the electrode 181a, and the piezoelectric layer between the electrode 171a and the electrode 181a. In the portion P1, the active region includes the piezoelectric layer between the electrode 171a and the electrode 181a.

In the present modification, the portion P2 includes the electrode 171b, the electrode 181b, and the piezoelectric layer between the electrode 171b and the electrode 181b. In the portion P2, the active region includes the piezoelectric layer between the electrode 171b and the electrode 181b.

In the present modification, the amplifier 20 is electrically connected to the electrode 171b. The oscillator 30 is electrically connected to the electrode 171a and the electrode 18. As a result, the oscillator 30 applies the voltage to the portion P1. In the present modification, the oscillator 30 applies the voltage to the electrode 171a and the electrode 18.

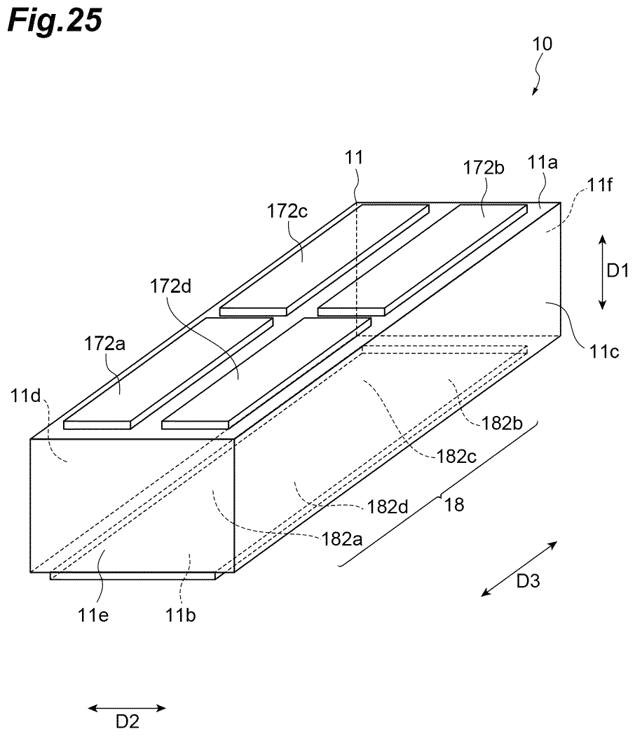

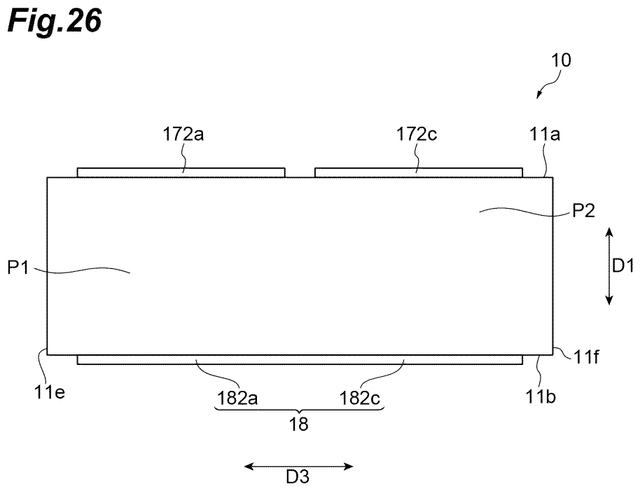

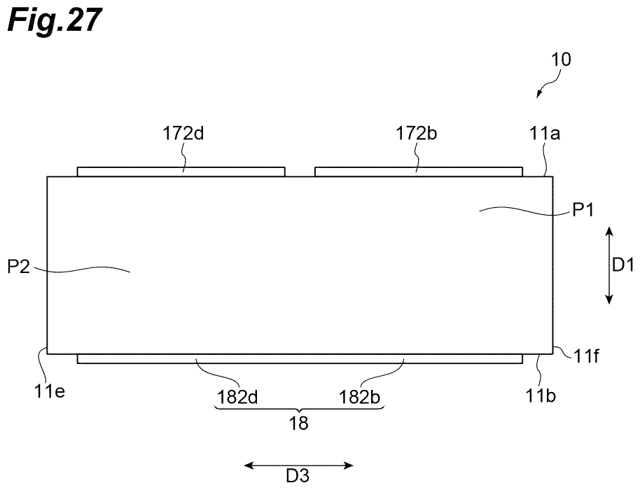

Next, a configuration of a seventh modification of the input device ID according to the present embodiment will be described with reference to FIGS. 25, 26, and 27. FIG. 25 is a perspective diagram of a piezoelectric element. FIG. 26 is a diagram illustrating a cross-sectional configuration of the piezoelectric element. FIG. 27 is a diagram illustrating a cross-sectional configuration of the piezoelectric element. In FIGS. 26 and 27, hatching is omitted to clearly illustrate each part. In the present modification, the configuration of the piezoelectric element 10 is different from that of the above-described fifth modification. Hereinafter, differences between the above-described fifth modification and the present modification will be mainly described.

In the present modification, the piezoelectric element 10 includes electrodes 172a, 172b, 172c, and 172d instead of the electrodes 17a and 17b. The electrodes 172a, 172b, 172c, and 172d have, for example, the rectangular shape.

As illustrated in FIG. 25, the electrodes 172a, 172b, 172c, and 172d are disposed on the principal surface 11a. On the principal surface 11a, the electrodes 172a and 172b are disposed, for example, at the one diagonal of the rectangular shape of the piezoelectric body 11. In the present modification, the electrode 172a is disposed at the corner formed by the side surface 11d and the end surface 11e, and the electrode 172b is disposed at the corner formed by the side surface 11c and the end surface 11f. On the principal surface 11a, the electrodes 172c and 172d are disposed, for example, at the other diagonal of the rectangular shape of the piezoelectric body 11. In the present modification, the electrode 172c is disposed at the corner formed by the side surface 11d and the end surface 11f, and the electrode 172d is disposed at the corner formed by the side surface 11c and the end surface 11e.

In the present modification, the electrode 18 includes an electrode 182a, an electrode 182b, an electrode 182c, and an electrode 182d. The electrodes 182a, 182b, 182c, and 182d are disposed on the principal surface 11b. On the principal surface 11b, the electrodes 182a and 182b are disposed, for example, at the one diagonal of the rectangular shape of the piezoelectric body 11. In the present modification, the electrode 182a is disposed at the corner formed by the side surface 11d and the end surface 11e, and the electrode 182b is disposed at the corner formed by the side surface 11c and the end surface 11f. On the principal surface 11a, the electrodes 182c and 182d are disposed, for example, at the other diagonal of the rectangular shape of the piezoelectric body 11. In the present modification, the electrode 182c is disposed at the corner formed by the side surface 11d and the end surface 11f, and the electrode 182d is disposed at the corner formed by the side surface 11c and the end surface 11e. In the present modification, the electrode 182a, the electrode 182b, the electrode 182c, and the electrode 182d are integrated.

As illustrated in FIGS. 26 and 27, the electrode 172a, the electrode 172b, the electrode 172c, and the electrode 172d disposed on the principal surface 11a face the electrode 18 disposed on the principal surface 11b with the part of the piezoelectric body 11. In the present modification, the electrode 172a disposed on the principal surface 11a opposes the electrode 182a disposed on the principal surface 11b with the piezoelectric layer. The electrode 172b disposed on the principal surface 11a opposes the electrode 182b disposed on the principal surface 11b with the piezoelectric layer. The electrode 172c disposed on the principal surface 11a opposes the electrode 182c disposed on the principal surface 11b with the piezoelectric layer. The electrode 172d disposed on the principal surface 11a opposes the electrode 182d disposed on the principal surface 11b with the piezoelectric layer.

In the present modification, the portion P1 includes the electrode 172a, the electrode 182a, and the piezoelectric layer between the electrode 172a and the electrode 182a. In the portion P1, the active region includes the piezoelectric layer between the electrode 172a and the electrode 182a.

The portion P1 includes the electrode 172b, the electrode 182b, and the piezoelectric layer between the electrode 172b and the electrode 182b. In the portion P1, the active region includes the piezoelectric layer between the electrode 172b and the electrode 182b.

In the present modification, the portion P2 includes the electrode 172c, the electrode 182c, and the piezoelectric layer between the electrode 172c and the electrode 182c. In the portion P2, the active region includes the piezoelectric layer between the electrode 172c and the electrode 182c.

The portion P2 includes the electrode 172d, the electrode 182d, and the piezoelectric layer between the electrode 172d and the electrode 182d. In the portion P2, the active region includes the piezoelectric layer between the electrode 172d and the electrode 182d.

In the present modification, the amplifier 20 is electrically connected to the electrodes 172c and 172d. The oscillator 30 is electrically connected to the electrodes 172a and 172b and the electrode 18. As a result, the oscillator 30 applies the voltage to the portion P1. In the present modification, the oscillator 30 applies the voltage to the electrode 172a and the electrode 18, and the electrode 172b and the electrode 18.

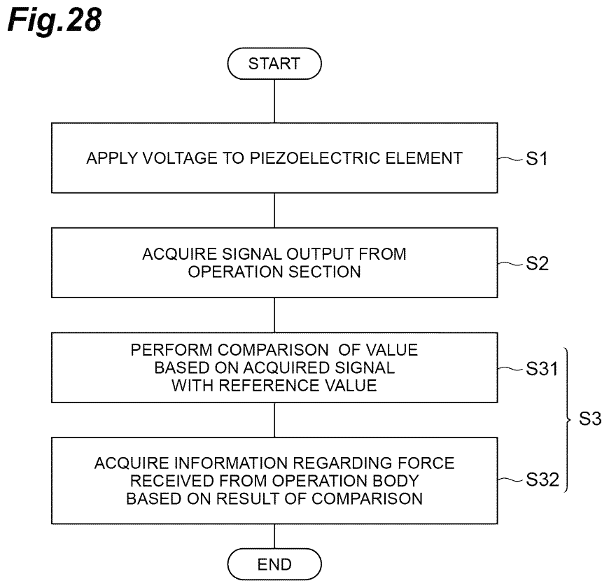

An example of the operation of the controller CU will be described with reference to FIG. 28. FIG. 28 is a flowchart illustrating an example of control processing in the input device.

In step S1, the oscillator 30 applies the voltage to the piezoelectric element 10. In this control processing, the oscillator 30 applies the voltage to the portion P1 of the piezoelectric element 10. For example, in a case where the oscillator 30 received an application command from the processor 50, the oscillator 30 applies the voltage to the portion P1. The processor 50 outputs the application command to the oscillator 30, for example, in a case where the processor 50 received information indicating that the piezoelectric element 10 has received a force from the operation body from a sensor (not illustrated). The processor 50 may receive a request from a user of the controller CU and output the application command to the oscillator 30.

In step S2, the processor 50 acquires a signal output from the operation section OU. In this control processing, the processor 50 acquires the digital signal output from the converter 40. That is, in step S2, the processor 50 acquires the voltage data obtained through converting the signal output from the operation section OU into digital data.

In step S3, the processor 50 acquires the information regarding the force received from the operation body. In the present control processing, step S3 includes step S31 and step S32.

In step S31, the processor 50 performs the comparison of the value based on the signal output from the operation section OU with the reference value. In the present control processing, the processor 50 obtains the difference between the value based on the signal output from the operation section OU and the reference value as the comparison between the value based on the signal output from the operation section OU and the reference value.

In step S32, the processor 50 acquires the information regarding the force received from the operation body based on the result of the comparison. In this control processing, the processor 50 refers to the information indicating the relationship between the difference obtained in step S31 and the value based on the magnitude of the force received from the operation body, and acquires the value corresponding to the calculated difference. Next, the processor 50 acquires the acquired value based on the magnitude of the force received from the operation body, as the information regarding the force received from the operation body. That is, in the present control method, the processor 50 acquires the information regarding the force received from the operation body based on the difference between the value based on the signal output from the operation section OU and the reference value.

As described above, the present control method discloses a method for controlling the input device ID including applying the voltage to the portion P1, acquiring the signal output from the operation section OU, and acquiring the information regarding the force received from the operation body based on the acquired signal.

In the present control method, the voltage is applied to the portion P1. Through applying the voltage to the portion P1, the portion P1 is displaced. As a result, the displacement of the portion P1 is transmitted to the portion P2, and the portion P2 displaced. When receiving the force on the piezoelectric element 10 from the operation body, a restraint force responding to the force acts on the piezoelectric body 11 including the portion P1 and the portion P2. Therefore, the force received on the piezoelectric element 10 from the operation body affects the ease of the displacement of the portion P2. That is, when receiving the force on the piezoelectric element 10 from the operation body, the displacement of the portion P2 changes responding to the force. As the displacement of the portion P2 changes, the electric charge generated in the portion P2 also changes.

In the present control method, since the voltage is applied to the portion P1 included in the piezoelectric body 11 together with the portion P2, the displacement of the portion P1 due to the application of the voltage is easily transmitted to the portion P2 as compared with the configuration in which the portion P1 and the portion P2 are included in separate piezoelectric bodies. Therefore, the displacement of the portion P2 appropriately changes responding to the force received from the operation body.

As described above, the present control method improves the accuracy of the information regarding the force received from the operation body.

In the present control method, acquiring the information regarding the force received from the operation body includes performing the comparison of the value based on the signal output from the operation section OU with the reference value, and acquiring the information regarding the force received from the operation body based on the result of the comparison.

Performing the comparison of the value based on the signal output from the operation section OU with the reference value accurately capture a change in the force that the piezoelectric element 10 receives from the operation body. Therefore, the present control method further improves the accuracy of the information regarding the force received from the operation body.

In the present control method, performing the comparison includes obtaining the difference between the value based on the signal output from the operation section OU and the reference value.

The difference between the value based on the signal output from the operation section OU and the reference value indicates an amount of the change from the reference value. Obtaining the amount of the change from the reference value more reliably and accurately capture the change in the force that the piezoelectric element 10 receives from the operation body. Therefore, the present control method more reliably improves the accuracy of the information regarding the force received from the operation body.

Although an embodiment and modifications of the present disclosure have been described above, the present disclosure is not necessarily limited to the above-described embodiment and modifications, and various alterations can be made without departing from the gist thereof.

In the above-described embodiment and modifications, the controller CU includes the oscillator 30, but the controller CU may not include the oscillator 30. That is, the input device ID may not include the oscillator 30. In a configuration in which the input device ID does not include the oscillator 30, another device different from the input device ID may include the oscillator 30.

In the embodiment and the modifications described above, the controller CU performs the comparison of the value based on the signal output from the operation section OU with the reference value, and acquires the information regarding the force received from the operation body based on the result of the comparison. However, the controller CU may acquire the information regarding the force received from the operation body without performing the comparison of the value based on the signal output from the operation section OU with the reference value.

In the configuration in which the controller CU acquires the information regarding the force received from the operation body without performing the comparison of the value based on the signal output from the operation section OU with the reference value, the processor 50 may acquire the information regarding the force received from the operation body as follows, for example. First, the processor 50 may refer to the information indicating the relationship between the value based on the signal output from the operation section OU and the value based on the magnitude of the force received from the operation body. Next, a value corresponding to the value based on the signal output from the operation section OU may be acquired. Next, the acquired value based on the magnitude of the force received from the operation body may be acquired as the information regarding the force received from the operation body.

In the embodiment and the modifications described above, the controller CU acquires the information regarding the force received from the operation body based on the difference between the value based on the signal output from the operation section OU and the reference value. However, the processing for acquiring the information regarding the force that the controller CU receives from the operation body is not limited to the above-described processing. For example, the controller CU may acquire the information regarding the force received from the operation body based on a ratio between the value based on the signal output from the operation section OU and the reference value.

In the configuration in which the controller CU acquires the information regarding the force received from the operation body based on the ratio between the value based on the signal output from the operation section OU and the reference value, the processor 50 may acquire the information regarding the force received from the operation body as follows, for example. First, the processor 50 may obtain the ratio between the value based on the signal output from the operation section OU and the reference value. Next, the processor 50 may refer to information indicating a relationship between the obtained ratio and the value based on the magnitude of the force received from the operation body, and acquire a value corresponding to the calculated ratio. Next, the processor 50 may acquire the acquired value based on the magnitude of the force received from the operation body as the information regarding the force received from the operation body.

What is claimed is:

1. An input device comprising:
an operation section including a piezoelectric element being arranged to receive a force from an operation body, the piezoelectric element including one piezoelectric body including a first portion being arranged to be displaced through application of a voltage and a second portion being arranged to generate an electric charge through displacement, the operation section being arranged to output a signal responding to the electric charge generated in the second portion; and
a controller being arranged to acquire information regarding the force received from the operation body based on the signal output from the operation section.

2. The input device according to claim 1, wherein the controller is arranged to perform a comparison of a value based on the signal output from the operation section with a reference value, the controller being arranged to acquire the information regarding the force received from the operation body based on a result of the comparison.

3. The input device according to claim 2, wherein the controller is arranged to perform the comparison of the value based on the signal output from the operation section with the reference value that is based on the signal output from the operation section in an initial state where no force is received from the operation body.

4. The input device according to claim 2, wherein the controller is arranged to acquire the information regarding the force received from the operation body based on a difference between the value based on the signal output from the operation section and the reference value.

5. The input device according to claim 1, wherein the operation section includes an amplifier being arranged to amplify a voltage generated in the second portion, the operation section being arranged to output the voltage amplified by the amplifier as the signal responding to the electric charge generated in the second portion.

6. The input device according to claim 1, wherein the controller includes a converter being arranged to convert the signal output from the operation section into a digital signal, the controller being arranged to acquire the information regarding the force received from the operation body based on the digital signal converted by the converter.

7. The input device according to claim 1, wherein the piezoelectric element includes a first internal electrode and a second internal electrode included in the first portion and opposing each other, and a third internal electrode and a fourth internal electrode included in the second portion and opposing each other.

8. The input device according to claim 7, wherein the second internal electrode and the fourth internal electrode are positioned in a same layer and are integrated.

9. The input device according to claim 7, wherein the first internal electrode and the third internal electrode are positioned in a same layer.

10. The input device according to claim 1, wherein the controller is arranged to output the voltage applied to the first portion.

11. A method for controlling an input device,
wherein the input device including an operation section including a piezoelectric element being arranged to receive a force from an operation body, the piezoelectric element including one piezoelectric body including a first portion being arranged to be displaced through application of a voltage and a second portion being arranged to generate an electric charge through displacement, the operation section being arranged to output a signal responding to the electric charge generated in the second portion,
the method comprising:
applying the voltage to the first portion;
acquiring the signal output from the operation section; and
acquiring information regarding the force received from the operation body based on the acquired signal.

12. The method for controlling the input device according to claim 11, wherein
the acquiring the information regarding the force received from the operation body includes:
performing a comparison of a value based on the signal output from the operation section with a reference value; and
acquiring the information regarding the force received from the operation body based on a result of the comparison.

13. The method for controlling the input device according to claim 12, wherein the performing the comparison includes obtaining a difference between the value based on the signal output from the operation section and the reference value.
